(19) United States
(12) Patent Application Publication
(10) Pub. No.: US 2026/0004778 A1
(43) Pub. Date: Jan. 1, 2026

(54) PROACTIVE TASK PLANNING AND EXECUTION

(71) Applicant: Amazon Technologies, Inc., Seattle, WA (US)

(72) Inventors: Vinaya Nadig, Bothell, WA (US); Samarth Bhargava, Redmond, WA (US); Supriya Medapati, Irvine, CA (US); Sunny Chiu Webster, Woodinville, WA (US); Omar Zia Khan, Clyde Hill, WA (US)

(21) Appl. No.: 18/755,234

(22) Filed: Jun. 26, 2024

(51) Int. Cl. G10L 15/22; G10L 15/18

(52) U.S. Cl. CPC G10L 15/22; G10L 15/18; G10L 2015/223

(57) ABSTRACT

Techniques for predicting an action(s) to perform for a user and, optionally, delivering proactive experiences are described. A system receives data usable to determine a predicted action of a user and invokes a generative model to process the data and determine the predicted action. The system may thereafter determine a system-performable action corresponding to the predicted action and determine a task(s) for executing the system-performable action. The system may also invoke the or another generative model to determine a trigger event(s) for triggering performance of the task(s). The system may receive an event indicating the trigger event(s) has occurred and, based thereon, perform the task(s). Alternatively, a generative model may determine proactive content is to be output during a dialog with the user and, based thereon, the system may perform the task(s).

### BACKGROUND

Natural language processing systems have progressed to the point where humans can interact with computing devices using their voices and natural language textual input. Such systems employ techniques to identify the words spoken and written by a human user based on the various qualities of received input data. Speech recognition combined with natural language understanding processing techniques enable speech-based user control of computing devices to perform tasks based on the user's spoken inputs. Such processing may be used by computers, hand-held devices, telephone computer systems, kiosks, and a wide variety of other devices to improve human-computer interactions.

### BRIEF DESCRIPTION OF DRAWINGS

For a more complete understanding of the present disclosure, reference is now made to the following description taken in conjunction with the accompanying drawings.

FIG. 1 is a conceptual diagram illustrating example processing of a system to generate a user-specific proactive task plan and execute same based on occurrence of an event, according to embodiments of the present disclosure.

FIG. 2 is a process flow diagram illustrating example processing performable by an action predictor component of the system, according to embodiments of the present disclosure.

FIG. 3 is a process flow diagram illustrating example processing performable by a proactive tasks planner component of the system, according to embodiments of the present disclosure.

FIG. 4 is a conceptual diagram illustrating example processing of the system to execute a proactive task plan based on a determination by a generative model, according to embodiments of the present disclosure.

FIG. 5 is a conceptual diagram illustrating example components of a system configured to use a generative model to determine a response to a user input, according to embodiments of the present disclosure.

FIG. 6 is a conceptual diagram illustrating example processing of the system configured to use a generative model, according to embodiments of the present disclosure.

FIG. 7 is a conceptual diagram illustrating example components of the system, according to embodiments of the present disclosure.

FIG. 8 is a block diagram conceptually illustrating example components of a device, according to embodiments of the present disclosure.

FIG. 9 is a block diagram conceptually illustrating example components of a system, according to embodiments of the present disclosure.

FIG. 10 illustrates an example of a network for use with the overall system, according to embodiments of the present disclosure.

### DETAILED DESCRIPTION

Automatic speech recognition (ASR) is a field of computer science, artificial intelligence, and linguistics concerned with transforming audio data associated with speech into a token or other textual representation of that speech. Similarly, natural language understanding (NLU) is a field of computer science, artificial intelligence, and linguistics concerned with enabling computers to derive meaning from natural language inputs (such as spoken inputs). ASR and NLU are often used together as part of a language processing component of a system. Text-to-speech (TTS) is a field of computer science concerning transforming textual and/or other data into audio data that is synthesized to resemble human speech. Natural language generation (NLG) is a field of artificial intelligence concerned with automatically transforming data into natural language (e.g., English) content. Speech-to-speech is a field of computer science, artificial intelligence, and linguistics in which embedding data is generated to represent speech in audio data and, using one or more models, the embedding data is processed to generate audio data and/or a system (e.g., API) command responsive to the speech. Language modeling (LM) is the use of various statistical and probabilistic techniques to determine the probability of a given sequence of words occurring in a sentence. LM can be used to perform various tasks including understanding a natural language input and performing generative tasks that involve generating natural language output data.

The present disclosure provides, among other things, techniques for predicting an action(s) to perform for a user and, in some instances, delivering proactive experiences (e.g., presenting news updates the user is interested in, short term price reduced deals the user is interested in, a ticket sale for an event nearby, or any other experience that helps the user accomplish daily tasks and/or interests).

As used herein, “proactive content” includes content that is generated in anticipation of a user explicitly requesting the specific content be generated, to inform the user about information that may be important/useful/relevant to the user.

As used herein, a “proactive task plan” refers to one or more tasks to be performed upon the occurrence of one or more trigger events. A trigger event may be time-based (e.g., delivering calendar summaries to a user at 7 am), tied to real-world happenings (e.g., the start of a sporting event or when the coffee machine is started in the morning), or linked to a user-specific incident (e.g., user entering a location, such as a living room). A proactive task plan can be deterministic in that is does not need a runtime inference loop.

In some embodiments, the present disclosure provides a centralized action prediction system that eliminates different systems having to independently implement action prediction and task planning processing. The system of the present disclosure is able, in some embodiments, to anticipate actions a user may request be performed and present timely, relevant suggestions or act on behalf of users.

The system of the present disclosure may account for different categories of user requested actions. For example, two users may both be interested in the same sports team, but their needs for proactive experiences can be completely different. For instance, the first user could be interested in going to sports bars where a group of fans can watch a game together, whereas the second user could be looking for ticket deals. Similarly, the first user could be interested in the history of the team, whereas the second user can be interested more about ongoing games, live updates, player status, etc. In a further example, the first user may be interested in merchandise, whereas the second user may be interested in game highlights. Other example differences are also possible. The system of the present disclosure is able to utilize various signals, relating to different users' explicit and inferred interests, to implement a tailored approach such that each user is presented with proactive content customized to the particular user's explicit and/or inferred needs.

A system of the present disclosure may receive various instances of data that can be used to determine/predict an action that may be requested by a user. For example, the various instances of data may indicate one or more interests identified by the user, one or more inferred interests of the user, one or more subscriptions (e.g., to particular system functionality) of the user, one or more instances of feedback provided by the user in response to one or more system outputs, one or more routines of the user (e.g., actions configured by the user to be performed in response to one or more corresponding trigger events), one or more devices the user has associated with the user profile and/or account, one or more items in the user's purchase history, etc.

The system may prompt a generative model (e.g., language model) to determine/predict one or more actions to be performed for the user based on examples of the received instances of data mentioned above. In some instances, the system may obtain the instances of data and utilize the generative model to predict the action in response to a particular trigger event. For example, the system may perform the foregoing processing in response to receiving a user preference update. Example user preference updates include, but are not limited to, a user updating a stored preference in the user's profile, a user subscribing to receive updates regarding an entity, content, or topic over time, and a user indicating information (e.g., about an entity or topic) is to be prevented from being presented to the user.

After the generative model predicts an action that may be requested by the user, the system may determine a system-performable action corresponding to the predicted action. For example, the generative model may output predicated action as natural language data and/or a computer-understandable command (e.g., application programming interface (“API”) data) and the system may determine a system-performable action involving one or more other system components (e.g., synthesized speech, smart home device directive to take an action, skill or other type of application directive to cause a specific response, etc.). Semantic characteristics are linguistic units (e.g., morphemes, words, sentences, etc.) of data that contribute to the meaning of the data. As used herein, data is “semantically similar” to other data when the meaning of the data is similar to that of the other data and/or when one set of data representing sematic characteristics is within a certain threshold distance in multi-dimensional vector space (e.g., “close”) to another set of data representing other semantic characteristics. For example, the system may convert predicted action data, as determined by the generative model, into a corresponding semantic embedding, and evaluate the similarity of the semantic embedding to existing semantic embeddings of system-performable actions to determine whether the predicted action embedding is semantically similar to one or more system-performable actions.

Following determining of the system-performable action, the system may determine one or more tasks to be performed to execute the system-performable action. For example, a system-perforable action may be to summarize the events of a day of an electronic calendar and corresponding tasks may be to obtain event data for a day of the electronic calendar, invoke a generative model to produce a summary of the event data, and present the summary using a device(s) of the user and/or send the summary to an account of the user. For further example, a system-performable action may be to turn on a sprinkler and corresponding tasks may be to obtain a sprinkler identifier(s) associated with a user's profile and use an API call to turn on the sprinkler(s) corresponding to the sprinkler identifier(s). As another example, a system-performable action may be to turn on a car at a specific time in the morning on weekdays before a user leaves for work and corresponding tasks may be to obtain a vehicle identifier associated with the user's profile and use an API call to turn on the vehicle.

The system may prompt a generative model (e.g., language model, which may be the same or different from the one used to predict the action that may be requested by the user) to determine one or more trigger events for triggering performance of the task(s). In some examples, the system may search a storage, including trigger events, to identify two or more trigger events relating to the predicted action and prompt the generative model to determine the one or more trigger events from the identified two or more trigger events.

The system may store a proactive task plan including the user's identifier, the one or more tasks, the one or more trigger events, and/or other data.

Sometime thereafter, the system may receive event data indicating the one or more trigger events has occurred and, based thereon, identify the stored proactive task plan corresponding to the particular trigger event(s). The system may use a generative model (e.g., language model, which may be the same or different from the one used to predict the action and/or the one used to determine the one or more trigger events) to cause the one or more tasks, from the proactive task plan, to be performed to generate proactive content, which may then be presented or indicated using one or more devices of the user.

In some instances, a generative model (e.g., language model, which may be the same or different from the one used to predict the action and/or the one used to determine the one or more trigger events and/or the one used to execute the proactive task plan) may be used to engage in a dialog (e.g., a virtual assistant dialog) with the user and, during the dialog, determine proactive content is to be presented to the user. Based thereon, the system may identify stored proactive task plans for the user, determine stored proactive content capable of being presented to the user, and, using a trained machine learning model, process the stored proactive task plans and proactive content to determine a singular proactive task plan to be performed. The system may then cause the proactive task plan to be performed to generate proactive content, which may then be presented or indicated using one or more devices of the user.

The present disclosure provides a computer-implemented method including (and a computing system configured to) receiving first data to determine a predicted action of a user, wherein the first data indicates at least one or more inferred interests of the user; generating first prompt data including the first data and a request to determine the predicted action based on the first data; using a language model to process the first prompt data and determine a description of the predicted action; performing a semantic query of a system-performable action storage to determine a system-performable action whose description is semantically similar to the description of the predicted action as determined by the language model; determining one or more tasks to be performed to execute the system-performable action; generating second prompt data including two or more trigger events and a request to determine one or more, of the two or more trigger events, for triggering performance of the one or more tasks; storing first proactive task plan data including a user identifier of the user, second data representing the one or more tasks, and third data representing the one or more trigger events; after storing the first proactive task plan data, receiving event data indicating the one or more trigger events has occurred; based on the event data corresponding to the one or more trigger events, identifying the first proactive task plan data in a storage component; after identifying the first proactive task plan data in the storage component, causing the one or more tasks to be performed to generate first proactive output data; and outputting the first proactive output data using one or more devices associated with the user identifier.

In some embodiments, the computer-implemented method further includes (or the computing system is further configured to) determining, by the language model during a dialog with the user, that proactive content is to be presented to the user; based on the language model determining proactive content is to be presented to the user, identifying a plurality of stored proactive task plan data associated with the user identifier of the user; determining proactive content data corresponding to at least one instance of proactive content capable of being presented to the user; processing the plurality of stored proactive task plan data and the proactive content data to determine, from among the plurality of stored proactive task plan data, that one or more tasks, in second proactive task plan data of the plurality of stored proactive task plan data, are to be performed; causing the one or more tasks of the second proactive task plan data to be performed to generate second proactive output data; and indicating the second proactive output data using one or more devices associated with the user identifier.

The present disclosure also provides a computer-implemented method including (and a computing system configured to) receiving first data indicating one or more interests of a user; generating first prompt data requesting a generative model determine a predicted action of the user based on the first data; using the generative model to process the first prompt data and determine the predicted action; determining one or more tasks to be performed to execute the predicted action; determining one or more trigger events for triggering performance of the one or more tasks; after determining the one or more trigger events, determining the one or more trigger events has occurred; based on the one or more trigger events occurring, causing the one or more tasks to be performed to generate first proactive output data; and outputting the first proactive output data using one or more devices of the user.

In some embodiments, the computer-implemented method further includes (or the computing system is further configured to) determining, by the generative model during a dialog with the user, that proactive content is to be presented to the user; based on the generative model determining proactive content is to be presented to the user, identifying a plurality of stored proactive task plan data associated with a user identifier of the user, the plurality of stored proactive task plan data comprising first proactive task plan data including the one or more tasks and the one or more trigger events; determining proactive content data corresponding to at least one instance of proactive content capable of being presented to the user; processing the plurality of stored proactive task plan data and the proactive content data to determine, from among the plurality of stored proactive task plan data, that the one or more tasks, in the first proactive task plan data, are to be performed; causing the one or more tasks to be performed to generate second proactive output data; and outputting the second proactive output data using one or more devices associated with the user identifier.

In some embodiments, the computer-implemented method further includes (or the computing system is further configured to) performing a search of a storage component, including data related to trigger events, to identify two or more trigger events relating to the predicted action as determined by the generative model; and using the generative model to determine the one or more trigger events from among the two or more trigger events.

In some embodiments, the computer-implemented method further includes (or the computing system is further configured to) receiving at least one of: second data indicating one or more system functionality subscriptions of the user, third data indicating one or more instances of feedback provided by the user in response to one or more system outputs, and fourth data indicating one or more actions configured by the user to be performed in response to one or more corresponding trigger events; and generating the first prompt data to request the generative model determine the predicted action further based on at least one of the second data, the third data, and the fourth data.

In some embodiments, the computer-implemented method further includes (or the computing system is further configured to) receiving second data indicating the user has updated a stored preference in user profile data; and using the generative model to process the first prompt data and determine the predicted action in response to receiving the second data.

In some embodiments, the computer-implemented method further includes (or the computing system is further configured to) receiving second data indicating one or more of: a first user input subscribing to receiving updates regarding an entity or topic over time, and a second user input indicating information about an entity or topic is to be prevented from being presented to the user; and using the generative model to process the first prompt data and determine the predicted action in response to receiving the third data.

In some embodiments, the computer-implemented method further includes (or the computing system is further configured to) determining a system-performable action corresponding to the predicted action as determined by the generative model; and determining application programming interface (API) data for executing the system-performable action.

In some embodiments, the computer-implemented method further includes (or the computing system is further configured to) processing the first prompt data to determine natural language data corresponding to the predicted action; and determining the system-performable action has a description that is semantically similar to the natural language data.

In some embodiments, the computer-implemented method further includes (or the computing system is further configured to) after determining the predicted action using the generative model, sending, to an events component, event data indicating the predicted action has been determined; and determining the one or more tasks based on the event data being sent to the events component.

As used herein, a “generative model” refers to a machine learning model that generates new data instances. A discriminative model, in contrast, discriminates between different kinds of data instances. For example, a generative model may generate a photo of animals that look like real animals, whereas a discriminative model can identify whether an image is of a dog or a cat (or other discrete animal categories). Example generative models include (large) language models.

Language models analyze bodies of text data to provide a basis for their word predictions. Some language models are generative models. In some embodiments, one or more of the language models of the system described herein may be a large language model (LLM). A language model is an advanced artificial intelligence system designed to process, understand, and generate human-like text based on relatively large amounts of data. In some embodiments, a language model (or another type of generative model) may be further designed to process, understand, and/or generate multi-modal data including audio, text, image, and/or video. A language model may be built using deep learning techniques, such as neural networks, and may be trained on extensive datasets that include text (or other type of data, such as multi-modal data including text, audio, image, video, etc.) from a broad range of sources, such as old/permitted books and websites, for natural language processing. An LLM uses a larger training dataset, as compared to a relatively smaller language model, and can include a relatively large number of parameters (in the range of billions, trillions or more), hence, they are called “large” language models. In some embodiments one or more of the language models (and their corresponding operations, discussed herein below) may be the same language model.

In some embodiments, a generative model may be transformer-based sequence-to-sequence (seq2seq) model involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, a generative model may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the generative model may be pre-trained for approximately 1 trillion tokens. Being trained on CLM tasks, the generative model may be capable of in-context learning. Examples of such a generative model include some of Amazon Alexa and Amazon Web Services (AWS) Titan family of generative models.

In other embodiments, the one or more language models may be a decoder-only architecture. The decoder-only architecture may use left-to-right (unidirectional) encoding of the input (e.g., audio, text, image, video, etc.). Examples of such a language model include others in the Amazon Alexa and AWS Titan family of models as well as the Generative Pre-trained Transformer 3 (GPT-3), GPT-4, and other versions of GPT. GPT-3 reportedly has a capacity of (approximately) 175 billion machine learning parameters. GPT-4 reportedly has a capacity of (approximately) 1.76 trillion machine learning parameters.

Other examples of language models (e.g., LLMs) include BigScience Large Open-science Open-access Multilingual Language Model (BLOOM), Language Model for Dialogue Applications model (LaMDA), Bard, Large Language Model Meta AI (LLAMA), etc.

In some embodiments, the system may include one or more other machine learning models (e.g., discriminative models) instead of or in addition to the generative models. Such machine learning model(s) may receive text and/or other types of data as inputs (e.g., audio, image, video, etc.), and may output text and/or the other types of data. Such model(s) may be neural network-based models, deep learning models, classifier models, autoregressive models, seq2seq models, etc.

An artificial intelligence (AI) system may comprise ASR, NLU, NLG, and/or TTS functionality, each with and/or without a language model or other type of generative model, for processing user inputs, including natural language inputs (e.g., typed and spoken inputs) and other type of inputs (e.g., inputs not received from a user, inputs received from a system component, inputs representing occurrence of events, etc.) and generating outputs. The AI system may use other types of generative models including a speech-to-speech model (that may process audio data and generate audio embedding data/audio tokens that can be used to generate synthesized speech), text-to-speech model (that may process text data or other textual representations and generate audio embedding/token data), speech-to-text model (that may process audio data and generate text data or other textual representations), image-to-text model (that may process image (or video) data and generate text data or other textual representations), text-to-image data (that may process text or other textual representations and generate image (or video) data), a multi-modal generative model (that may process one or more types of input data (e.g., text, audio and/or image) and generate one or more types of output data (e.g., text, audio, and/or image)), and other types.

A generative model may receive an input in the form of a prompt. A prompt may be a natural language input, for example, a directive or request, for the generative model to generate an output according to the prompt. The output generated by the generative model may be a natural language output responsive to the prompt. In some embodiments, the output may additionally or instead be another type of data, such as audio, image, video, etc. The prompt and the output may be text in a particular language (e.g., English, Spanish, German, etc.). For example, for the prompt “how do I cook rice?”, the generative model may output a recipe (e.g., a step-by-step process represented by text, audio, image, video, etc.) to cook rice. As another example, for the prompt “I am hungry. What restaurants in the area are open?”, the generative model may output a list of restaurants near the user that are open at the time of the user prompt.

A generative model may be configured (e.g., trained) using various learning techniques. For example, in some embodiments, a generative model may be configured using a few-shot learning. In few-shot learning, the model learns how to learn to solve the given problem. In this approach, where the model is provided with (e.g., in the prompt) a limited number of exemplars (i.e., “few shots”) from the new task, and the model uses this information to adapt and perform well on that task. Few-shot learning may require fewer amount of training data than implementing other fine-tuning techniques. For further example, a generative model may be configured using one-shot learning, which is similar to few-shot learning except the model is provided with a single exemplar (e.g., in the prompt). As another example, a generative model may be configured using zero-shot learning. In zero-shot learning, the model solves the given problem without exemplars of how to solve the problem and just based on the model's training dataset. In this approach, the model is provided with data not observed during training, and the model learns to generate an appropriate output based on its learning of other data.

A system according to the present disclosure may be configured to incorporate user permissions and may only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

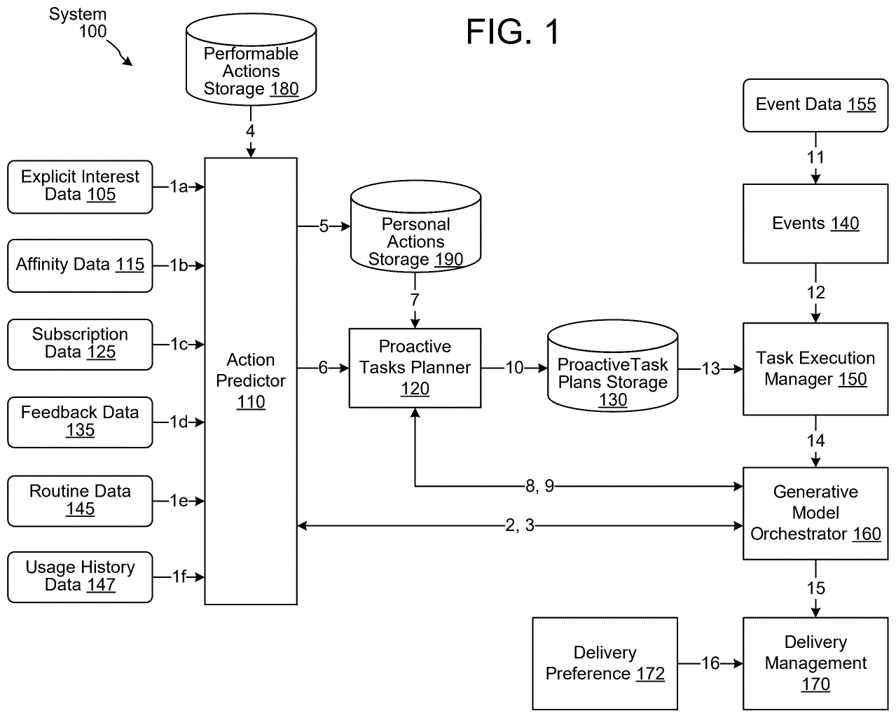

FIG. 1 illustrates example processing of a system 100 to generate a user-specific proactive task plan and execute same based on occurrence of an event. As illustrated the system 100 may include a action predictor component 110, proactive tasks planner component 120, proactive task plans storage 130, events component 140, task execution manager component 150, generative model orchestrator component 160, performable actions storage 180, personal actions storage 190, a delivery management component 170, and a delivery preference component 172, which may be implemented, in some embodiments, as part of one or more “system components” described elsewhere herein.

The action predictor component 110 may process in the background and predict actions that may be requested by users of the system 100. A predicted action may be the output of information likely to be useful to the user, the performance of an action the user would otherwise likely request the system 100 perform, etc.

In some embodiments, the action predictor component 110 may process according to a schedule (e.g., daily, weekly, monthly, etc.). In other embodiments, the action predictor component 110 may process in response to a user interacting with the system 100 in a manner that indicates the user's preference (or lack thereof) for something. For example, the action predictor component 110 may subscribe to the events component 140 to receive “user preference update” event data, and may process in response to receiving such event data. User preference update event data may correspond to, for example, a user updating a stored preference (e.g., sports team preference, music genre preference, etc.) in the user's profile, a user providing an input requesting ongoing output of information about an entity over time (e.g., a user subscribing to receive updates regarding an entity), a user providing an input requesting ongoing output of information about a topic over time (e.g., a user opting in to receive updates pertaining to the topic), and a user indicating information about an entity or topic should no longer be presented to the user.

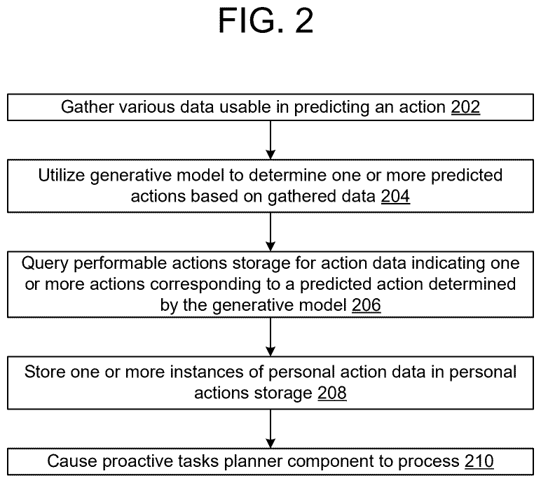

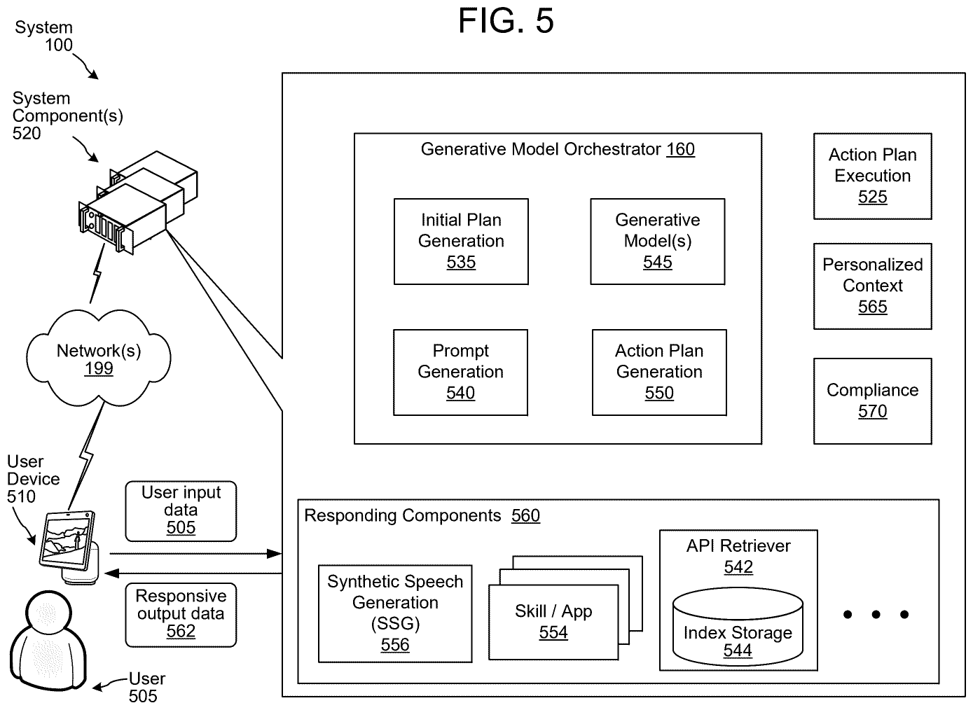

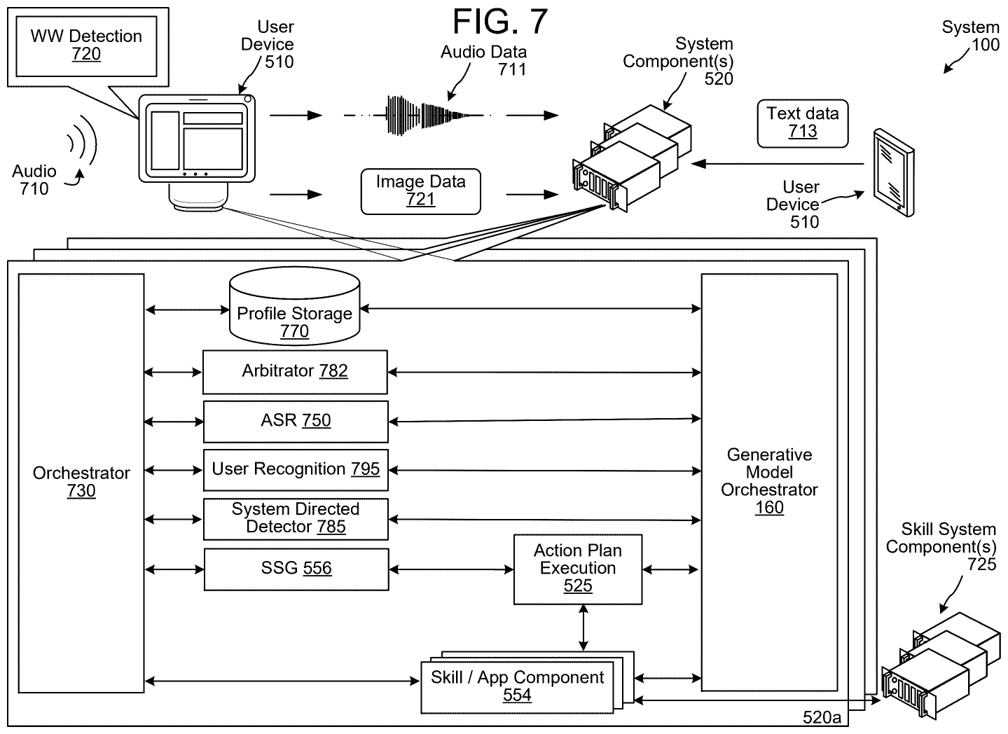

When the action predictor component 110 is triggered to process (e.g., according to a schedule or in response to a user-system interaction indicating a preference of the user), the action predictor component 110 may gather (step 202 in FIG. 2) various data that can be used in predicting an action that may be requested by the user. For example, and as illustrated in FIG. 1, the action predictor component 110 may call one or more components of the system 100 to receive (steps 1a-1e in FIG. 1) explicit interest data 105, affinity data 115, subscription data 125, feedback data 135, routine data 145, and/or usage history data 147. As the action predictor component 110 is processing to predict an action for a particular user, the information in the explicit interest data 105, affinity data 115, subscription data 125, feedback data 135, routine data 145, and usage history data 147 may be associated with the same user identifier. In some embodiments, the action predictor component 110 may receive data from a personalized context component 565 (illustrated in and described with respect to FIG. 5) and/or a profile storage 770 (illustrated in and described with respect to FIG. 7).

The explicit interest data 105 includes information pertaining to interests explicitly indicated by the user. For example, the explicit interest data 105 may indicate one or more entities (e.g., persons, places, or things) the user has indicated is of interest to the user. For further example, the explicit interest data 105 may indicate one or more topics the user has indicated is of interest to the user. As another example, the system 100 may ask the uses what entity(ies) and/or topic(s) is of interest to the user and the explicit interest data 105 may indicate one or more entity(ies) and/or topic(s) identified by the user in response to the question(s).

The affinity data 115 includes information pertaining to interests the system 100 deduced for the user. For example, the system 100 may include a component (e.g., a trained machine learning model or generative model) that processes user inputs of the user (and/or other data related to the user) and therefrom determines one or more affinities (e.g., interests) of the user, with the one or more affinities being represented in the affinity data 115. The user inputs, from which the user's affinity (ies) is/are determined, are not limited to any particular modality. For example, the affinity (ies) may be deduced from one or more spoken inputs, one or more typed natural language inputs, one or more gesture-based inputs, one or more graphical user interface (GUI) inputs, etc. As an example, the component (e.g., a trained machine learning model or generative model) may determine a user likes a particular genre of music by processing the music the user has requested the system output and/or based on the user purchasing a one or more tickets to one or more concerts.

The subscription data 125 includes information pertaining to one or more explicit subscriptions of the user (i.e., associated with the user's identifier). The subscription data 125 may include information corresponding to system functionality/component/service subscriptions (e.g., music service subscriptions, video service subscriptions, skill subscriptions, etc.). The subscription data 125 may additionally or alternatively include information corresponding to event-based topic notification subscriptions (e.g., subscriptions to be notified when a sporting event starts, subscriptions to be notified when there is a severe weather alert for a location, etc.).

The feedback data 135 includes information pertaining to feedback the user provided to the system 100 with respect to system outputs/actions/responses of the system with respect to previous inputs of the user. For example, the user may ask for music by an artist, the system may output a song of the artist, the user may respond by indicating the user does not like the output song, and the user's indication of not liking the song may be represented in the feedback data 135.

The routine data 145 includes information pertaining to one or more routines configured by the user. As used herein, a “routine” refers to one or more actions the user has explicitly requested be performed by the system 100 based on one or more corresponding trigger events (e.g., on a regular basis, such as daily, weekly, etc.) at a certain time, in response to the user's presence being detected at a particular location, etc.). For example, a routine may include turning on a smart light every day at 7 pm. For further example, a routine may include presenting the user with a summary of their electronic calendar every morning.

The usage history data 147 includes information pertaining to one or more previous user inputs of the user. The usage history data 147 is not intended to be limited to any particular type of user input. For example, the usage history data 147 may represent one or more spoken user inputs, one or more typed natural language user input, one or more gestures, one or more user inputs corresponding to selection of GUI elements, etc. In some embodiments, the usage history data 147 may include a text or tokenized representation of a user input. In some embodiments, a user input may be associated in the usage history data 147 with a timestamp of the user input, a type of the user input, and/or any other context pertaining to the user input and which may be usable by the action predictor component 110.

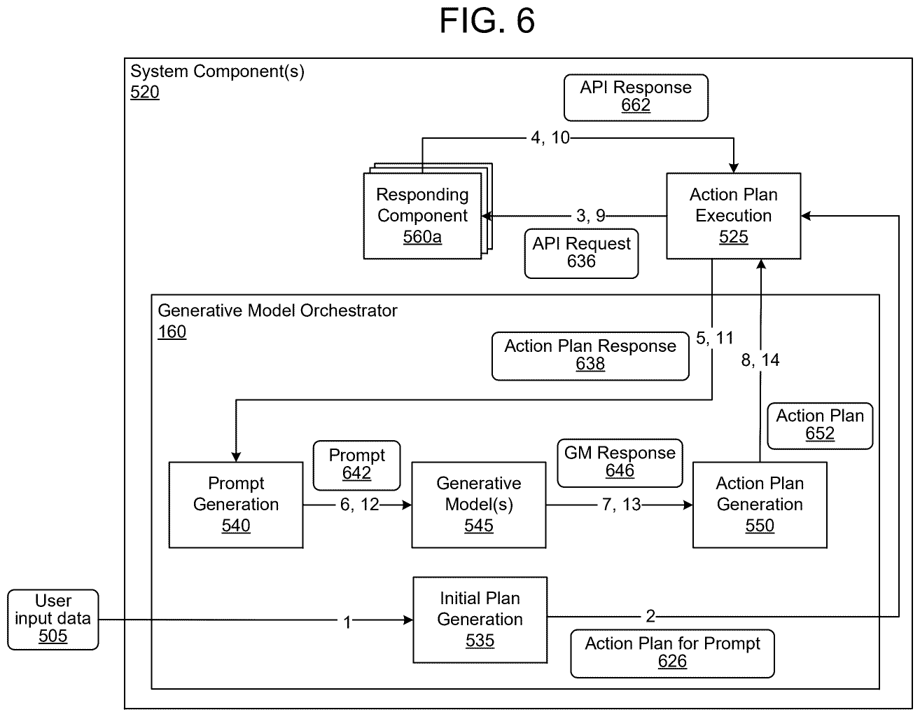

The action predictor component 110 may utilize (step 204 in FIG. 2) a generative model 545 (illustrated in FIGS. 5 and 6) to determine one or more predicted action for the user based on the gathered data (e.g., one or more of the explicit interest data 105, affinity data 115, subscription data 125, feedback data 135, routine data 145, and usage history data 147). To this end, the action predictor component 110 may generate a prompt for the generative model 545 to determine one or more predicted actions. An example of such a prompt may be:
As a smart personal assistant, deduce predicted actions for a person with the following explicit interests: [list of interests, topics], affinities: [list of affinities], and routine(s): [description of routine(s)], etc. Consider their past interactions, current situation, and any recent events that might influence their actions.

The action predictor component 110 may send (step 2 in FIG. 1) prompt data, corresponding to the foregoing prompt, to the generative model orchestrator component 160.

The generative model orchestrator component 160 may send the prompt data to the generative model 545, which may process the prompt therein to determine one or more predicted actions for the user. For example, if the prompt data indicates the user has asked for electronic calendar updates around 7 pm or 8 pm, the generative model 545 may determine the user likely to request electronic calendar summaries around 7 pm or 8 pm. As another example, if the prompt data indicates the user routinely asks for a summary of an electronic calendar, the generative model 545 may determine the user is likely to request the system 100 perform meeting conflict resolution processing when a new meeting is added to the user's electronic calendar and conflicts with another meeting already in the calendar. In some embodiments, the generative model 545 may output a predicted action in the form of natural language. The generative model orchestrator component 160 may send (step 3 in FIG. 1) predicted action data to the action predictor component 110, where the predicted action data includes one or more descriptions of one or predicted actions for the user as determined by the generative model 545.

The action predictor component 110 may communicate with the performable actions storage 180. The performable actions storage 180 may store data corresponding to one or more actions performable by the system 100. Example actions include generating an electronic calendar summary, turning on/off a smart light, locking a smart lock, outputting music, audibly and/or visually presenting the news, etc. An action may be performed using a single application programming interface (API). Alternatively, an action may require task decomposition and scheduling by components of the system 100, as discussed herein with respect to FIGS. 5 and 6.

The action predictor component 110 may query (step 4 in FIG. 1 and step 206 in FIG. 2) the performable actions storage 180 for action data indicating one or more actions (e.g., including one or more action identifiers) corresponding to a predicted action determined by the generative model 545. For example, when the generative model 545 outputs a description of a predicted action as natural language data, the action predictor component 110 may perform a semantic search query on the performable actions storage 180 to determine one or more actions whose descriptions are semantically similar/relevant to the natural language data. For example, the system may convert the natural language predicted action description data, as output by the generative model, into a corresponding semantic embedding, and query the performable actions storage 180 to determine one or more action description embeddings that satisfy some similarity threshold with respect to the predicted action semantic embedding.

After receiving the action data, the action predictor component 110 may store (step 5 in FIG. 1 and step 208 in FIG. 2) one or more instances of personal action data in the personal actions storage 190, where an instance of personal action data includes the user's identifier, the predicted action as determined by the generative model 545, and an action from the action data corresponding to the predicted action. For example, an instance of personal action data may include the user's identifier, natural language data of the predicted action, and an action identifier.

After the action predictor component 110 stores the one or more instances of personal action data in the personal actions storage 190, the action predictor component 110 may cause (step 6 in FIG. 1 and step 210 in FIG. 2) the proactive tasks planner component 120 to process. For example, the action predictor component 110 may publish “actions updated” event data to the events component 140 and the events component 140 may send the actions updated event data to the proactive tasks planner component 120 (based on the proactive tasks planner component 120 subscribing to receive such event data), thereby causing the proactive tasks planner component 120 to process.

The proactive tasks planner component 120 computes proactive task plans to execute actions as represented by personal action data in the personal actions storage 190. More specifically, the proactive tasks planner component 120 determines when and how to commence a proactive experience to execute an action(s) predicted by the action predictor component 110.

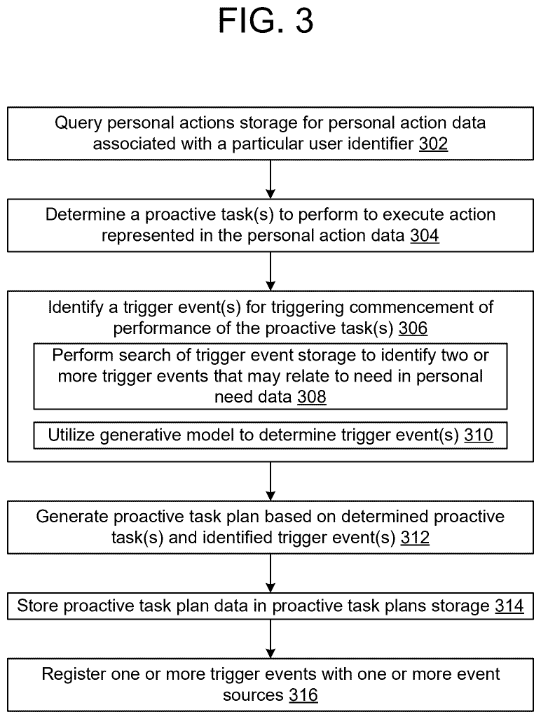

The proactive tasks planner component 120 queries (step 7 in FIG. 1 and step 302 in FIG. 3) the personal actions storage 190 for personal action data associated with a particular user identifier. For example, if the proactive tasks planner component 120 receives actions updated event data including a user identifier, the proactive tasks planner component 120 may query the personal actions storage 190 for personal action data associated with or including the user identifier from the actions updated event data.

The proactive tasks planner component 120 may determine (step 304 in FIG. 3) one or more tasks to be performed to execute the action represented in personal action data received in response to the query at step 302. In some embodiments, the proactive tasks planner component 120 may determine one or more tasks to be performed for each instance of received personal action data. For example, if personal action data includes an action to summarize events for a day of an electronic calendar, the proactive tasks planner component 120 may determine tasks of calling an electronic calendar API to obtain events for a (present) day in the electronic calendar and prompting a generative model to generate a summary of the obtained events. As can be appreciated, in certain instances the system may not determine a task for each user query received (particularly for mundane queries) but for purposes of illustration, the description focuses on queries for which these operations are performed.

In some embodiments, the proactive tasks planner component 120 may store or have access to a lookup table including performable tasks. The proactive tasks planner component 120 may implement a trained machine learning model that takes the tasks and action and determines one or more tasks that are semantically similar to the action.

The proactive tasks planner component 120 also identifies (step 306 in FIG. 3) one or more trigger events for triggering commencement of performance of the task(s) determined by the proactive tasks planner component 120 to be performed to execute the action in the personal action data. In some embodiments, the proactive tasks planner component 120 may utilize (step 310 in FIG. 3) the generative model 545 to determine the trigger event(s). For example, the proactive tasks planner component 120 may store (or have access to a storage including) a list of trigger events detectable by the system 100. The proactive tasks planner component 120 may generate a prompt for the generative model 545 to determine one or more trigger events for the task(s). An example of such a prompt includes “As a smart personal assistant, deduce which of the following trigger events: [list of trigger events] should be used to trigger the following task(s): [task(s)].” In some embodiments, the proactive tasks planner component 120 may perform (step 308 in FIG. 3) a (elastic) search of the storage including the list of trigger events to identify two or more trigger events that may relate to the action in the personal action data being processed by the proactive tasks planner component 120, and the proactive tasks planner component 120 may include the identified two or more trigger events (as opposed to all trigger events represented in the trigger event storage) in the prompt to the generative model 545. The proactive tasks planner component 120 may send (step 8 in FIG. 1) prompt data, corresponding to the foregoing prompt, to the generative model orchestrator component 160.

The generative model orchestrator component 160 may send the prompt data to the generative model 545, which may process the prompt therein to determine one or more trigger events for use in triggering the task(s). In some embodiments, the generative model 545 may output the trigger event(s) in the form of natural language. The generative model orchestrator component 160 may send (step 9 in FIG. 1) trigger event data to the proactive tasks planner component 120, where the trigger event data indicates one or more trigger events as determined by the generative model 545.

In some embodiments, instead of including candidate trigger events in the prompt to the generative model 545, the proactive tasks planner component 120 may generate the prompt to instruct the generative model 545 to obtain the trigger events from the storage. An example of such a prompt includes “As a smart personal assistant, deduce one or more trigger events for triggering the following task(s): [task(s)]. Here is an API for obtaining possible trigger events: [API information].”

The proactive tasks planner component 120 generates (step 312 in FIG. 3) a proactive task plan based on the determined task(s) and trigger event(s). For example, the proactive tasks planner component 120 may generate proactive task plan data to include a user identifier (i.e., from the from the actions updated event data and associated with (or included in) the personal action data), the task(s), and the trigger event(s).

The proactive tasks planner component 120 stores (step 10 in FIG. 1 and step 314 in FIG. 3) the proactive task plan data in the proactive task plans storage 130. The data in the proactive task plans storage 130 may be indexed in a manner that permits querying of the proactive task plans storage 130 based on user identifier and trigger event(s) to efficiently identify a corresponding task(s) to be performed. An example of a proactive task plan to deliver timely calendar summaries includes:

```
taskPlan: [{
  planId: <UUID>
    triggers: [
        {type: timeTrigger; value:“7:30am PT”; conditions:[“weekdays”]},
        {type: presenceDetected; value: “userid”; conditions:[”weekday
      mornings”]}
    ],
    TasksList: [
        {utterance: “Summarize my calendar and notify”,
      taskIds:[CalendarLookup, Summarize, Notify]}
    ]
  }]
```

The proactive tasks planner component 120 may also register (step 316 in FIG. 3) one or more trigger events with one or more event sources (e.g., the events component 140 and/or one or more other event data publishing components). For example, the proactive tasks planner component 120 may register the task execution manager component 150 to receive event data corresponding to the trigger event(s) of proactive task plan data in the proactive task plans storage 130, thereby enabling the task execution manager component 150 to be notified when trigger events occur so the task execution manager component 150 may commence proactive user experiences at appropriate times. As an example, the proactive tasks planner component 120 may register the task execution manager component 150 to receive event data corresponding to scheduled time-based trigger events (e.g., generated by an alert service), user presence and location trigger events, notification trigger events, trigger events from a routine triggers API, etc. If a proactive task plan involves staying informed about new releases by an artist, the proactive tasks planner component 120 may register the task execution manager component 150 to receive event data about the artist and add the user identifier from the proactive task plan to a user cohort interested in the artist. This may ensure that when a new song release event occurs, the user, along with other users in the cohort, are informed promptly and efficiently.

The events component 140 may receive and dispatch event data. The events component 140 may receive event data from a component of the system 100 (e.g., event data corresponding to processing performed by the system 100). Alternatively, the events component 140 may receive event data based on a component of the system 100 scraping the internet for events.

The events component 140 may receive event data that triggers a proactive experience for a single user. Alternatively, the events component 140 may receive event data that triggers a proactive experience for multiple users. For example, the system 100 may determine multiple users may request to be notified when a sporting event starts, and the events component 140 may trigger notifying the different users in response to receiving event data indicating the sporting event is starting/has started.

Sometime after the proactive task plan data is stored (step 10 in FIG. 1 and step 314 in FIG. 3) in the proactive task plans storage 130 and after the proactive tasks planner component 120 optionally registers (step 316 in FIG. 3) one or more trigger events with one or more event sources, the events component 140 may receive (step 11 in FIG. 1) event data 155.

The events component 140 may determine the task execution manager component 150 is registered to receive the event data 155 and, based thereon, may send (step 12 in FIG. 1) the event data 155 to the task execution manager component 150. The task execution manager component 150 may determine a user identifier(s) included in the event data 155 and query (step 13 in FIG. 1) the proactive task plans storage 130 for proactive task plan data associated with (or including) the user identifier(s) and being associated with (or including) trigger event data that corresponds to (e.g., is satisfied by) the event data 155. The task execution manager component 150 may send (step 14 in FIG. 1) received proactive task plan data (received in response to the query of step 13) to the generative model orchestrator component 160.

The generative model orchestrator component 160 may cause components of the system to process, as described herein below with respect to FIGS. 5 and 6, to perform an action (e.g., activate a sprinkler or irrigation system) on behalf of the user and/or generate an output for presentation to the user corresponding to the user identifier in the proactive task plan data. Since the action and/or output is performed and/or generated based on the predicted action, the action and/or output may be referred to as a “proactive” or “inferred” action and/or output since the user did not explicitly request the system 100 perform the action and/or generate the output.

The generative model orchestrator component 160 may send (step 15 in FIG. 1) the proactive output data to the delivery management component 170. The delivery management component 170 manages the delivery of proactive output data to a user (i.e., determines how proactive output data should be presented to a user). In some embodiments, the delivery management component 170 may determine proactive output data should be indicated only if one or more devices of the intended recipient are not in a “do not disturb” mode (i.e., device identifiers of the one or more devices are not associated with do not disturb indicators/flags).

The delivery management component 170 may also determine preferences for how proactive output data should be indicated to the intended recipient. For example, the delivery management component 170 may determine a preference(s) of the intended recipient (i.e., the user corresponding to the user identifier in the proactive task plan data from which the proactive output data was generated. In some embodiments, the preference(s) of the intended recipient may be determined from a subscription(s) of the intended recipient. A preference(s) may indicate an output type for indicating the proactive output data (e.g., activation of a light indicator, display of a GUI element, vibration of a device, etc.) and/or when (e.g., time of day, day of week, etc.) the proactive output data may be indicated.

The delivery management component 170 may determine an output type(s) for indicating proactive output data. The delivery management component 170 may determine the output type(s) based on a preference(s) of the intended recipient and/or characteristics/components of one or more devices of the intended recipient.

The user (and more particularly the user profile data of the user) may be associated with one or more devices configured to notify the user using one or more techniques. For example, the user may be associated with one or more devices configured to notify the user, that proactive output data is available for output, by activating a light indicator (e.g., a light ring, light emitting diode (LED), etc.) in a particular manner (e.g., exhibit a particular color, blink in a particular manner, etc.); displaying a GUI element, such as a banner, card, or the like; vibrating in a particular manner (e.g., at a particular vibration strength, particular vibration pattern, etc.); and/or use some other mechanism. The delivery management component 170 may determine which device(s) and which notification mechanism(s) should be used to notify the user that the proactive output data is available for output.

The delivery management component 170 may determine how to notify the user(s) of the proactive output data based on device characteristics. The delivery management component 170 may query a profile storage 770 (illustrated in FIG. 7) for device characteristic data associated with one or more device identifiers associated with the user identifier associated with the proactive output data. A given device's device characteristic data may represent, for example, whether the device has a light(s) capable of indicating the proactive output data is available for output, whether the device includes or is otherwise in communication with a display capable of indicating the proactive output data is available for output, and/or whether the device includes a haptic component capable of indicating the proactive output data is available for output.

The delivery management component 170 may indicate the proactive output data is available for output based on the device characteristic data. For example, if the delivery management component 170 receives first device characteristic data representing a first device includes a light(s), the delivery management component 170 may send, to the first device, a first command to activate the light(s) in a manner that indicates the proactive output data is available for output. In some situations, two or more devices of the user may be capable of indicating the proactive output data is available for output using lights of the two or more devices. In such situations, the delivery management component 170 may send, to each of the two or more devices, a command to cause the respective device's light(s) to indicate the proactive output data is available for output.

The delivery management component 170 may additionally or alternatively receive second device characteristic data representing a second device includes or is otherwise in communication with a display. In response to receiving the second device characteristic data, the delivery management component 170 may send, to the second device, a second command to display text, an image, a popup graphical element (e.g., a banner) that indicates the proactive output data is available for output. For example, the displayed text may correspond to “you have an unread notification.” But the text may not include specifics of the proactive output data. An example of the second command may be a mobile push command.

In some situations, two or more devices of the user may be capable of indicating the proactive output data is available for output by displaying content. In such situations, the delivery management component 170 may send, to each of the two or more devices, a command to cause the respective device to display content indicating the proactive output data is available for output.

The delivery management component 170 may additionally or alternatively receive third device characteristic data representing a third device includes a haptic component. In response to receiving the device characteristic data, the delivery management component 170 may send, to the third device, a third command to vibrate in a manner that indicates the proactive output data is available for output.

The delivery management component 170 may determine how to indicate the proactive output data is available for output based on a user preference(s) corresponding to the user identifier in the proactive task plan data from which the proactive output data was generated. For example, the delivery management component 170 may query (step 16 in FIG. 1) the delivery preference component 172 for one or more indication preferences associated with the user identifier. An indication preference may indicate whether proactive output data is to be indicated using a light indicator, displayed content, vibration, and/or some other mechanism. An indication preference may indicate proactive output data, corresponding to a particular topic, is to be indicated using a light indicator, displayed content, vibration, and/or some other mechanism.

The delivery management component 170 may additionally or alternatively determine how to indicate the proactive output data is available for output based on a preference of the system component that provided the event data 155 to the events component 140. For example, the event data 155 may indicate the proactive output data is to be indicated using a light indicator, displayed content, vibration, and/or some other mechanism.

In some situations, the delivery management component 170 may determine no device of the user is capable of indicating the proactive output data as preferred by either the user preference(s). In such situations, the delivery management component 170 may cause the device(s) of the user to indicate the proactive output data according to characteristics of the device(s).

In some situations, while the device(s) is indicating the proactive output data is available for output, the system 100 may generate additional proactive output data intended for the same user. Thus and in some embodiments, after receiving the additional proactive output data, the delivery management component 170 may determine whether a device(s) of the user is presently indicating proactive output data is available for output.

The delivery management component 170 may determine a user identifier associated with the additional proactive output data, and determine one or more device identifiers (e.g., device serial numbers) associated with the user identifier, and determine whether at least one of the one or more device identifiers is associated with data (e.g., a flag or other indicator) representing a device(s) is presently indicating proactive output data is available for output. If the delivery management component 170 determines a device(s) is presently indicating proactive output data is available for output, the delivery management component 170 may cease processing with respect to the additional proactive output data (and not send an additional command(s) to the device(s)). Conversely, if the delivery management component 170 determines no devices of the user are presently indicating proactive output data is available for output, the delivery management component 170 may determine how the proactive output data is to be indicated to the user (as described herein above).

In some embodiments, the delivery management component 170 may determine to present proactive output data without taking the preliminary step of first indicating the proactive output data is available for output. For example, the delivery management component 170 may cause a device to display proactive output data as part of a “home screen widget.” For further example, the delivery management component 170 may determine the user is presently interacting with the generative model 545 via a web browser or mobile application and may cause the web browser or mobile application to display the proactive output data as part of the user-system dialog.

In some situations, the task execution manager component 150 may receive proactive task plan data, from the proactive task plans storage 130, that simply indicates the user is to be notified of proactive output data included in the proactive task plan data. In such situations, the task execution manager component 150 may send the proactive task plan data to the delivery management component 170 (without also sending the proactive task plan data to the generative model orchestrator component 160, and the delivery management component 170 may process as described herein to deliver the proactive output data in the proactive task plan data.

The delivery management component 170 may maintain a record of delivered proactive content. If an important, time critical proactive content is not retrieved by the user, the delivery management component 170 may cause one or more devices of the user to re-indicate the proactive content is available at an appropriate time based on signals such as, for example, user presence detection and historical activity.

The delivery management component 170 may determine if proactive content indicated by one device needs to be dismissed on one or more other devices. For example, if a user reads proactive content on a mobile device, the delivery management component may cause notification of the proactive content to be dismissed from all other devices of the user outputting such notifications.

In situations where multiple instances of proactive content are ready for output to the user, The delivery management component 170 may cause the generative model 545 to summarize the various instances of proactive content and present the summary in a consolidated format (e.g., like on a home screen widget).

The delivery management component 170 may facilitates user re-engagement with proactive content. For example, if a user is busy at the time one or more of the user's devices indicate proactive content is available, the delivery management component 170 may cause the proactive content to be accessible at a later time by the user in a “notifications center” of a user interface.

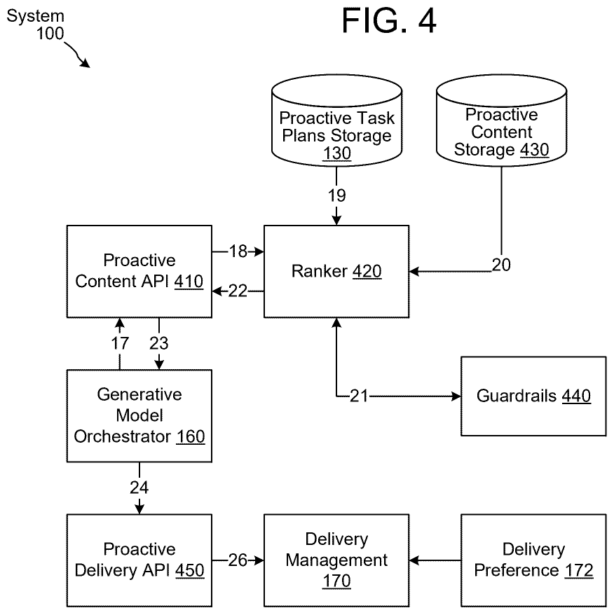

FIG. 4 is a conceptual diagram illustrating example processing of the system to execute a proactive task plan based on a determination by the generative model 545. For example, during a dialog with a user, the generative model 545 may determine inferred/proactive content should be output to the user. This determination may be made based on the generative model 545 determining the dialog has ended, receiving a user input corresponding to a particular topic or entity with respect to which the system is storing proactive content, etc.

Based on this determination, the generative model orchestrator component 160 may call (step 17 in FIG. 4) a proactive content API 410 (e.g., an example of a responding component 560 illustrated in and described with respect to FIGS. 5 and 6) to obtain one or more instances of proactive content that could be presented to the user. The proactive content API 410 may be used to obtain proactive content tailored to specific user's needs, profiles, and/or locations. The proactive content API 410 may be used to obtain proactive content regardless of the manner in which the proactive content is to be presented. The call to the proactive content API 410 may include the user identifier of the user presently interacting with the generative model 545. In response to receiving the call, the proactive content API 410 may call (step 18 in FIG. 4) a ranker component 420 to obtain the one or more instances of proactive content that could be presented to the user. The call to the ranker component 420 may include the user identifier of the user presently interacting with the generative model 545.

The ranker component 420 may perform two functions: (i) retrieve proactive content data from a proactive content storage 430 storing proactive content data provided by one or more proactive content providers; and (ii) rank, filter, and shortlist retrieved proactive content data using, among other things, proactive task plan data stored in the proactive task plans storage 130. Use of the proactive task plan data may ensure the user is presented with proactive content the user most likely is interested in receiving.

As mentioned above, the proactive content storage 430 may store proactive content data provided by one or more proactive content providers. As used herein, a “proactive content provider” refers to a computing system or component configured to provide proactive content data to the proactive content storage 430. In some instances, a proactive content provider may be a skill. As used herein, a “skill” refers to software, that may be placed on a machine or a virtual machine (e.g., software that may be launched in a virtual instance when called), configured to process data representing a user input and perform one or more actions in response thereto. In some instances, a skill may process NLU output data to perform one or more actions responsive to a user input represented by the NLU output data. What is described herein as a skill may be referred to using different terms, such as a processing component, an application, a bot, or the like.

The ranker component 420 may query (step 19 in FIG. 4) the proactive task plans storage 130 for proactive task plan data representing one or more proactive task plans associated with the user identifier (i.e., of the user presently interacting with the generative model 545) in the proactive task plans storage 130. The ranker component 420 may thereafter query (step 20 in FIG. 4) the proactive content storage 430 for proactive content data usable in executing the received one or more proactive task plans.

The ranker component 420 may implement a machine learning (ML) model finetuned to optimize one or more proactive success metrics defined to prioritize proactive task plans, focusing on user engagement and satisfaction considering recent user feedback and user preferences along with situational context. To this end, the ranker component 420 may rank instances of proactive task plan data, corresponding to different proactive task plans, received at step 19 based on whether the proactive content storage 430 included proactive content data usable in executing the proactive task plan data, user feedback associated with the user identifier of the presently interacting with the generative model 545 (e.g., user feedback received within a past threshold amount of time), one or more preferences of the instant user (e.g., one or more preferences in a user profile associated with the user's identifier), and/or other context data (e.g., a location of the user, characteristics of the user's devices, subscriptions of the user, etc.).

In some embodiments, the ranker component 420 may communicate (step 21 in FIG. 4) with a guardrails component 440 (which may be implemented as part of or separately from a compliance component 570 illustrated in and described with respect to 5) that implements one or more policies for ensuring a beneficial user experience. That is, the guardrails component 440 is configured to make a determination as to whether proactive task plan data should be presented to the user based on one or more policies. The ranker component 420 may send proactive task plan data and the user's identifier to the guardrails component 440. In some embodiments, the ranker component 420 may have access to and send the most recent user input of the user to the guardrails component 440.

The guardrails component 440 may communicate with (or include) a policy storage that, generally, stores policies indicating when proactive content data should not be presented. For example, a policy may indicate a device should not indicate proactive content is available (e.g., via activation of a light indicator, display of a GUI element, vibration, etc.) during a particular time period (e.g., from 10 pm to 5 am). For further example, a policy may indicate a maximum frequency (i.e., maximum number of times within a certain time period) that proactive content may be output to a user. In another example, a policy may indicate a minimum amount of time (e.g., at least 30 minutes) that should elapse between instances of proactive content data being presented to a single user. For further example, a policy may indicate proactive content should only be output using a particular device or device type. In another example, a policy may indicate proactive content should only be output when the user/device is at or near a particular location (e.g., the user's home). It will be appreciated that the foregoing policies are illustrative, and the present disclosure is not limited to the specific example policies provided.

The guardrails component 440 compares received proactive task plan data (and optionally corresponding proactive content data) against the policies in the policy storage to assess whether the proactive task plan data should be prevented from being executed (e.g., the proactive content data should be prevented from being presented).

The guardrails component 440 may send (step 22 in FIG. 4), to the ranker component 420, data indicating whether a particular instance of proactive task plan data is to be prevented from being executed.

In some situations, proactive task plan data, received by the ranker component 420 at step 19, may correspond to proactive content that changes frequently (e.g., product deal information, news, etc.). The ranker component 420 may be configured to call one or more APIs to obtain up-to-date information. For example, if proactive task plan data includes a task of output product deal information, the ranker component 420 may call a shopping action API to obtain up-to-date product deal information. For further example, if proactive task plan data includes an action to output news information, the ranker component 420 may call a news action API to obtain up-to-date news information.

After the ranker component 420 ranks instances of proactive task plan data received at step 19 (and optionally after the ranker component 420 invokes the guardrails component 440 and/or obtains up-to-date information), the ranker component 420 may send (steps 22 and 23 in FIG. 4) all or a portion of the ranked instances of proactive task plan data to the generative model orchestrator component 160 via the proactive content API 410. In some embodiments, the ranker component 420 send the top (or bottom) ranked instance of proactive task plan data to the generative model orchestrator component 160. In other embodiments, the ranker component 420 may send up to a threshold number of instances of proactive task plan data to the generative model orchestrator component 160.

In situations where the generative model orchestrator component 160 receives more than one instance of proactive task plan data, the generative model orchestrator component 160 may cause the generative model 545 to be prompted to determine which of the received instances of proactive task plan data is to be executed.

After the generative model orchestrator component 160 receives a single instance of proactive task plan data or after the generative model 545 determines which instance of proactive task plan data is to be executed, the generative model orchestrator component 160 may cause components of the system to process, as described herein below with respect to FIGS. 5 and 6, to generate an output for presentation to the user corresponding to the proactive task plan data. Since the output is generated based on the proactive task plan data, the output may be referred to as a “proactive” or “inferred” output since the user did not explicitly request the system 100 generate the output.

The generative model orchestrator component 160 may call (step 25 in FIG. 4) a proactive delivery API 450 with the user's identifier and the proactive output data. The proactive delivery API 450 may in turn cause (step 26 in FIG. 4) the user's identifier and the proactive output data to be send to the delivery management component 170. The delivery management component 170 (and optionally the delivery preference component 172) may thereafter process to present the user with the proactive output data (as described above with respect to FIG. 1).

FIG. 5 illustrates further example components included in the system 100 configured to use a language-model based approach to determine an action to be performed in response to a user input and determine a response to be presented to a user 505. As shown in FIG. 5, the system 100 may include a user device 510, local to the user 505, in communication with one or more system component(s) 520 via a network(s) 199. The network(s) 199 may include the Internet and/or any other wide- or local-area network, and may include wired, wireless, and/or cellular network hardware.

In some embodiments, the system component(s) 520 may include various components that may support processing by a generative model, such as a generative model orchestrator component 160. In example embodiments, the generative model orchestrator component 160 may include an initial plan generation component 535, a prompt generation component 540, at least one generative model 545, and an action plan generation component 550. The system component(s) 520 may further include an action plan execution component 525 configured to facilitate/cause performance of actions that may be determined by the generative model 545. The system component(s) 520 may further include one or more responding components 560 that may perform the actions.

The responding components 560 may be configured to perform an action related to a user input, including, but not limited to retrieving information potentially relevant for determining a response to the user input (e.g., data from a knowledge base, Internet search, database, an application, etc.; context related to the interaction; relevant exemplars for a prompt to the generative model; relevant application programming interfaces (APIs); etc.), operating a user device (e.g., a smart home device such as a TV, lights, a kitchen appliance, etc.), determining a synthesized speech output, or other actions described herein. As shown in FIG. 5, the responding components 560 may include an API retriever component 542 (further described below), a synthesized speech generation (SSG) component 556, one or more skill/app components 554 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA.question (“Who is the president of USA?”) corresponds to a command for a component to find and provide an answer to the indicated question), and performing other actions (e.g., generating synthesized speech, searching data sources, etc.). The system 100 may interact with the responding components 550 via API calls.

The generative model orchestrator component 160 may be configured to orchestrate processing by the generative model 545. In some embodiments, the generative model 545 may be configured to perform one or more stages of processing, which may be referred to as a task generation stage, an action (or directive) generation stage, and a response generation stage.

The processing stages may be performed in a particular order. For example, during a first stage of processing, the generative model 545 may be tasked with performing task generation to generate a list of tasks to be performed in order to respond to a user input. During a second stage of processing, based on the list of tasks, the generative model 545 may be tasked with performing action generation to generate action requests (or directives) for a responding component(s) 560 to perform an action(s) related to the tasks/user input. During a third stage of processing, based on information received from the responding component(s) 560, the generative model 545 may be tasked with generating a response to the user input and/or causing a component(s) of the system 100 to perform further action(s). Further details are described herein in relation to FIG. 6.

In some cases, a subset of the stages may be performed. For some user inputs, the generative model 545 may only perform the task generation stage and the response generation stage, where a response to a user input is generated by the generative model 545 using parametric knowledge. For example, for a user input “What kind of fruit is lemon?”, the generative model 545 may determine that the task is to answer the user's question and may generate a response “Lemon is a citrus fruit that grows on tress” based on the model's parameter knowledge learned during configuration/training operations. In such examples, the generative model 545 may not determine an action that is to be performed using a system component, such as sending a request for information to a knowledge base (e.g., the generative model 545 may respond without using external knowledge).

In some embodiments, the system may use Retrieval-Augmented Generation (RAG) techniques to inform processing of a generative model. RAG techniques may involve referencing an authoritative knowledge base or other type of data source outside of the model's training data sources before generating a response by the model. RAG techniques may extend the already powerful capabilities of generative models to specific domains, an organization's internal knowledge base, etc., without the need to retrain the model. In some embodiments, information (e.g., relevant facts, up-to-date information, current/trending topics, etc.) from one or more components (e.g., responding component(s) 560) may be provided to the generative model 545 and the model may generate a output based on the received information.

In some embodiments, the generative model orchestrator component 160 may be configured to orchestrate processing by multiple different generative models, where an individual generative model may perform one (or more) of the processing stages described above. For example, a first generative model may perform task generation, a second generative model may perform action generation, and a third generative model may perform response generation. In some embodiments, the generative models may be different types of models, for example, a first generative model may be a text-to-text generative model, a second generative model may be a multi-modal generative model, a third generative model may be a text-to-speech generative model, etc. In some embodiments, the generative models may be different sizes (e.g., number of parameters), may have different processing capabilities, etc.

Some embodiments may enable use of other components, such as plugins, with the generative model 545, where the plugins may add functionality and features to the generative model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the generative model. As a further example, the plugins may cause the generative model to process and output according to an enabled plugin, which may result in a different response, reasoning, processing, etc. from the generative model than when the plugin is not enabled. In some cases, a user or a system may enable a plugin(s) for use with the generative model.

The system component(s) 520 may include other processing components configured to process user inputs and other type of inputs (e.g., sensor data, audio data, data indicative of an event occurring, etc.) received via the user device 510. In example embodiments, the system component(s) 520 may process spoken inputs using ASR processing. The system component(s) 520 may also be configured to process non-spoken inputs, such as gestures, textual inputs, selection of GUI elements, selection of device buttons, etc. The system component(s) 520 may also include other components to understand an input, determine an action to be performed in response to receiving the input, generate an output responsive to the input, and the like. Such other components may perform natural language processing, SSG processing, etc., some of which are described herein in relation to FIG. 7.

As shown in FIG. 5, the system component(s) 520 may receive the user input data 505, which may be provided to the generative model orchestrator component 160 (as shown in FIG. 6).

FIG. 6 illustrates example processing of the user input data 505 by the system component(s) 520 using the generative model 545. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the generative model 545 may perform iterative processing (e.g., multiple processing cycles, multiple processing stages, etc.) with respect to individual user input data 505. Such iterative processing is illustrated and described herein with respect to FIG. 6. For example, in a first iteration of processing the generative model 545 may receive a first prompt from the prompt generation component 540, in response to which the generative model 545 may determine one or more tasks to be performed with respect to the user input data 505, then at least one of the determined task(s) may be performed via the action plan execution component 525, the results of the performed task(s) may be provided to the generative model 545 via a second prompt, in response to which the generative model 545 may determine further tasks to be performed or may determine that a (final) response to the user input is determined.

The initial plan generation component 535 may be configured to determine various information relevant to processing of the user input data 505 by the generative model orchestrator component 160. The initial plan generation component 535 may generate an action plan (e.g., action plan for prompt data 626) representing one or more tasks/actions to be performed to determine the various relevant information. The relevant information may be included in a prompt to the generative model 545. The initial plan generation component 535 may receive (step 1) the user input data 505 representing a user input from the user 505. Based on the user input data 505, the initial plan generation component 535 may determine information relevant for processing the user input data 505 and may output (step 2) the action plan for prompt data 626. The action plan for prompt data 626 may include one or more tasks to be performed to retrieve the relevant information. The tasks may be represented as action descriptions, API requests/calls, API descriptions, requests to a component(s) (e.g., the responding components 560), and the like. Examples tasks that may be included in the action plan for prompt data 626 may relate to obtaining certain information like context data, user profile data, user preferences, available/relevant exemplars, available/relevant APIs, etc.

In example embodiments, the initial plan generation component 535 may determine one or more types of context data relevant for the user input data 505. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 505 corresponds to operation of a device (e.g., the user input corresponds to a smart home domain), the initial plan generation component 535 may determine that device context information, in particular device states for the devices associated with the user/user profile of the user 505, may be relevant information. As another example, if the user input data 505 corresponds to output of media, such as music, movies, TV shows, etc., the initial plan generation component 535 may determine that user context information, in particular user preference for media genre associated with the user/user profile of the user 505, may be relevant information.

Based on the type of context data determined to be relevant, the initial plan generation component 535 may output the action plan for prompt data 626 to include a request for the type(s) of context data. For example, if device context is relevant information, then the action plan for prompt data 626 may include an API call/description corresponding to a component (e.g., a device state component, a smart home component, a user profile storage, etc.) capable of providing device information. As another example, if user context is relevant information, then the action plan for prompt data 626 may include an API call/description corresponding to a component (e.g., a user profile storage, a personalized context component, etc.) capable of providing user information.

In some embodiments, the initial plan generation component 535 may determine one or more components or types of components that may be relevant for processing the user input data 505. As an example, if the user input data 505 corresponds to operation of a device (e.g., the user input corresponds to a smart home domain), the initial plan generation component 535 may determine that components (e.g., APIs) corresponding to device operation or smart home domain may be relevant, and the initial plan generation component 535 may output the action plan for prompt data 626 to include device operation components or smart home domain components. As another example, if the user input data 505 corresponds to output of media, the initial plan generation component 535 may determine components corresponding to media output or music domain may be relevant, and the initial plan generation component 535 may output the action plan for prompt data 626 to include media output components or music domain components.

In some embodiments, the initial plan generation component 535 may determine a query to retrieve exemplars and/or APIs relevant for processing the user input data 505 using the generative model 545. As used herein, an exemplar refers to information that may be included in a prompt to a generative model that provides an example of how the generative model is to process or respond, including, among other things, what actions the generative model can request performance of. A prompt may include more than one exemplar. Few shot learning or in-context learning by the generative model is enabled by including the exemplars in the prompt. The query (or request) to retrieve relevant exemplars and/or APIs may be included in the action plan for prompt data 626. The query (or an API request based on the query) may be processed by the responding component 560 (e.g., an exemplar retriever component, the API retriever component 542, etc.). The query, in some embodiments, may include the user input data 505 or a portion or representation thereof.

The initial plan generation component 535 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 535 may determine a topic/category corresponding to the user input data 505, a (semantically or lexically) similar past user input and relevant information corresponding to the similar past user input, and the like.

In example embodiments, the initial plan generation component 535 may use a generative model to determine the types of information relevant for processing the user input data 505. The initial plan generation component 535 may input a prompt to the generative model, for example, “What types of information is relevant for responding to the user input: [user input data 505]”, and the generative model may output one or more types of context data, one or more types of components, etc. that may be relevant. In some embodiments, the initial plan generation component 535 may input a prompt to the generative model 545 requesting relevant information for the user input data 505.

The action plan for prompt data 626, which includes types of relevant information for the user input data 505 or tasks to be performed to obtain the relevant information, may be processed by the action plan execution component 525 to retrieve the relevant information. The action plan execution component 525 may process the action plan for prompt data 626 to generate one or more requests to perform an action (e.g., API requests 636) for a particular responding component 560. For example, if the action plan for prompt data 626 indicates that device information/context is relevant, then the action plan execution component 525 may generate an API request 636 for a responding component 560a capable of providing the device information, where the API request 636 may include a user profile identifier associated with the user 505, a device identifier associated with the user device 510, and/or other information based on information required in the API call for the responding component 560a.

The API request 636 may be sent (step 3) to the corresponding responding component(s) 560. The responding component(s) 560 may include components that the action plan execution component 525 may communicate with via API requests or other type requests. As shown in FIG. 5, the responding component(s) 560 may include one or more skill/app components 554, the SSG component 556 (e.g., configured to convert input data to audio data representing synthesized speech), and the API retriever 542 (e.g., configured to provide APIs and corresponding information supported by the system 100). The responding component(s) 560 may also include an orchestrator component 730 (e.g., configured to facilitate processing by other system components 520 such as those shown in FIG. 7), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a generative model-based agent (e.g., a component that uses a generative model (e.g., a LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or generative model output), and the like.

In response to receiving the API request 636 (at step 3), the responding component(s) 560 may provide (step 4) an API response(s) 662 to the action plan execution component 525. At step 3, the API request(s) 636 is based on the action plan for prompt data 626, and thus, at step 4, the API response(s) 662 may include information relevant for processing the user input data 505. In examples, the API response(s) 662 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 626.

In example embodiments, the API request 636 may be sent to the API retriever component 542. In such cases, the API request 636 may include a query to retrieve relevant APIs based on the user input data 505. The API retriever component 542 may be configured to receive a search query and output one or more APIs or API data corresponding to (e.g., satisfying, matching, etc.) the search query. API data may include an API call, an API description, and other information associated with the API. In some embodiments, the API retriever component 542 may include or may be in communication with an index storage 544 (shown in FIG. 5). The index storage 544 may store various information associated with multiple APIs. Examples of information stored in the index storage 544 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 544 may include other information associated with the API, such as historical accuracy/defect rate, historical latency value, feedback (e.g., user satisfaction/feedback, system-based feedback), etc. The index storage 544 may also include sample user inputs corresponding to the API, where the sample user input may represent a user input for which the API can perform an action for.

The API retriever component 542 may apply one or more retrieval techniques to determine API data corresponding to the search query. For example, the API retriever component 542 may compare one or more APIs included/represented in the index storage 544 to the user input data 505 represented in the search query to determine one or more APIs (top-k list). Such comparison may involve a semantic comparison between the user input data 505 and the API data. In some embodiments, the API retriever component 542 may use a neural-based retrieval technique that may involve determining an encoded representation of the user input/search query and comparing (e.g., using cosine distance) the encoded representation(s) of the API data in the index storage 544. The relevant APIs may be included in the API response 662.

In a non-limiting example, for a user input “book a flight”, the API retriever component 542 may determine one or more API calls corresponding to booking a flight (e.g., Bookflight.location (“departing airport code”, “arrival airport code”), Bookflight.date (“departing date”), bookflight.rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 542 in terms of implementing one or more retrieval techniques to determine exemplars corresponding to (e.g., satisfying, matching, etc.) a search query based on the user input data 505. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 505. The retrieved exemplars may be included in the API response 662.

The information from the API response(s) 662 may be included in a prompt to the generative model 545. The action plan execution component 525 may determine action plan response data 638 based on the API response(s) 662. The action plan execution component 525 may combine (e.g., aggregate, summarize, de-duplicate, etc.) multiple API responses 662 to generate the action plan response data 638. In some examples, the action plan response data 638 may be the same or similar to the API response(s) 662. The action plan execution component 525 may send (step 5) the action plan response data 638 to the prompt generation component 540.

Using the action plan response data 638, the prompt generation component 540 may determine prompt 642 for the generative model 545. The prompt 642 may be a natural language input (e.g., a natural language request, a natural language instruction, etc.). In some embodiments, the prompt 642 may include information in a manner that the generative model 545 is trained for. The prompt generation component 540 may send (step 6) the prompt 642 to the generative model 545, where the prompt 642 may include the user input data 505 (or a representation of the user input data 505) and the relevant information for processing the user input data 505. For example, the prompt 642 (at step 6) may include relevant context data, relevant APIs or API descriptions, etc. that may be included in the action plan response data 638. In some embodiments, the prompt 642 may include a request or directive for the generative model 545 to respond to the user input data 505. In some embodiments, the prompt 642 may include one or more exemplars (e.g., in-context learning examples) for processing the user input data 505.

The prompt 642 may include indicators (e.g., labels, specific tokens, etc.) to identify certain information. In example embodiments, the prompt 642 may include a “User” indicator (to indicate that the following string of characters/tokens are the user input), an “Exemplar” indicator (to indicate exemplars), and so on.

In some embodiments, the prompts for the generative model described herein may include a request for the generative model to output a response that satisfies certain conditions. Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 642 may include an indication the processing stages (e.g., the task generation stage, the action generation stage, and the response generation stage) that the generative model 545 is to perform. In some examples, for the task generation stage, the prompt 642 may direct the generative model 545 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 642 may also direct the generative model 545 to prioritize a list of tasks to be performed, if more than one task is to be performed and select one (or more) task for the current iteration of processing.

In some examples, for the action generation stage, the prompt 642 may direct the generative model 545 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 642 may direct the generative model 545 to process the results of the action(s)/API(s) determined by the generative model 545, and to determine whether a response to the user input can be generated or whether there are further tasks to be performed from the task list.

In some examples, for the response generation stage, the prompt 642 may direct the generative model 545 to generate an output (e.g., tokens) representing a response (e.g., a final response) to the user input data 505. In examples, the generative model 545 may be directed to generate the response based on the results of performing the action(s)/API(s).

The prompt generation component 540 may send (step 6) the prompt 642 to the generative model 545, which may process the prompt 642 to generate a generative model (GM) response 646. The GM response 646 may be a natural language output generated based on the prompt 642. The GM response 646 may include text tokens. In other embodiments, where the generative model 545 may be a multi-modal model, the GM response 646 may include other types of tokens, for example, audio tokens, image tokens, etc.

Based on receiving the prompt 642 at step 6, the generative model 545 may generate the GM response 646 at step 7, where the instant GM response 646 may include outputs corresponding to the task generation stage and the action generation stage. The GM response 646 may include an action for determining information relevant to or responsive to the user input data 505. For example, the GM response 646 may include an action to search a knowledge base (e.g., to find a response to a user question), an action to determine information from a particular skill/app or generative model-based agent (e.g., to determine current weather information, to determine a cost of an item, to book travel, etc.), an action to operate a device (e.g., turn on lights, set thermostat to a particular temperature, etc.), an action to request information from the user 505, etc.

In some embodiments, the GM response 646 may include an API or API description corresponding to the determined action. For example, the GM response 646 may include an API to operate a device or an API call(s) to output media content. The generative model 545 may determine the actions and/or the API information based on the relevant APIs included in the prompt 642. The generative model 545 may generate actions and/or API information that is not based on (e.g., correspond to, is similar to, etc.) the relevant APIs included in the prompt 642 (for example, the generative model 545 may generate incorrect/unsupported actions and/or API information).

The GM response 646 may follow the format included in the prompt 642 or that the generative model 545 is trained to follow. An example prompt 642 may be:

```
  {
  Please process the following user input and context data to determine at least one action
or API to execute and generate a response to the user.
  First determine a task to perform (use “Task” label), then determine an API to perform
the task (use “Action” label), then process the results from the API, and then generate a response
to the user input (use “Response” label). You may determine multiple tasks to perform. You may
have to process iteratively.
  User: Turn on living room TV
  Available context:
    User devices: “living room TV” = [device id]
    “living room TV” device state = Off
  Available APIs:
    TurnOn.device (device)
    TurnVolumeUp.device (device)
    SetTVChannel (device, input channel)
  }
```

Based on processing the above example prompt 642, an example GM response 646 (at step 7) may be:

{
Task: User wants to turn on living room TV that is operation of a user device.
Action: I need an API to operate a device. TurnOn.device (device = “living room TV”)
}

The GM response 646 may be sent (step 7) to the action plan generation component 550, which may determine action plan data 652. As described herein, the generative model 545 may generate tokens in sequence, as such, the generative model 545 may generate portions of the GM response 646 in a tokens-by-tokens basis. In some embodiments, the GM response 646 may be processed by the action plan generation component 550 based on the generative model 545 generating the tokens representing the action or corresponding to the action generation stage.

The action plan generation component 550 may process the GM response 646 to identify one or more actions/APIs generated by the generative model 545. In examples, the action plan generation component 550 may parse the tokens/text included in the GM response 646 to extract tokens/text representing an action or API. In some embodiments, the action plan generation component 550 may be configured to determine one or more components (e.g., responding components 560a-n) configured to perform the identified action or API. Based on the GM response 646, the action plan generation component 550 may determine the action plan data 652, which may in turn cause performance of an action (e.g., execution of API calls) to determine a potential responses(s) to the user input. The action plan data 652 may include one or more APIs to be executed, where the APIs may be determined based on (e.g., extracted from) the GM response 646. For example, if the GM response 646 includes an action of “determine weather forecast for today” or an API call of “GetWeather.location ([city])”, then the action plan generation component 550 may determine the action plan data 652 to include an API call “GetWeather.location ([city])” and include an identifier for the responding component(s) 560a (e.g., a weather skill component). Instead of or in addition to an API call, the action plan data 652 may include a request to perform an action, an API description, etc. In some embodiments, the action plan generation component 550 may determine the responding components 560 based on user permissions, subscriptions, authorization or other use-enabling information associated with the user 505 (e.g., included in user profile data).

In some embodiments, the action plan generation component 550 may be configured to determine more than one responding component 560 to perform the action/execute the API indicated in the GM response 646. In some embodiments, the action plan generation component 550 may determine APIs corresponding to multiple responding components 560. For example, for the “GetWeather.location ([city])” API, the action plan data 652 may include an identifier for a first weather skill component, an identifier for a second weather skill component, an identifier for a search engine component, etc.

The action plan data 652 may be sent (step 8) to the action plan execution component 525. The action plan execution component 525 may identify the APIs in the action plan data 652 and generate executable API calls for the corresponding responding components 560. Based on the action plan data (received at step 8), the action plan execution component 525 may generate an additional (a second) API request (or multiple API requests) 636. The (additional/second) API request(s) 636 may be sent (step 9) to the responding component(s) 560. For example, the action plan execution component 525 may send a first API call to a first responding component 560a and a second API call to a second responding component 560b.

In some cases, the action plan data 652 may include incomplete API calls and the action plan execution component 525 may be configured to generate executable API calls (e.g., complete API calls) corresponding to the action plan data 652.

The action plan execution component 545 may generate one or more executable API calls including one or more parameters using information included in the action plan data 652 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the generative model orchestrator component 160. Prior to generating the executable commands, the action plan execution component 545 may modify (e.g., remove, filter, preempt, etc.) a directive included in the action plan data 652 that is determined to be in conflict with a system operating policy. The action plan execution component 545 may generate one or more additional executable commands corresponding to directives not included in the action plan data 652.

In response to receiving the API request(s) 636 (at step 9), the responding component(s) 560 may send (step 10) an (additional/second) API response(s) 662 to the action plan execution component 525. The action plan execution component 525 may determine (additional/second) action plan response data 638 based on the (additional/second) API response(s) 662. The action plan execution component 525 may combine (e.g., aggregate, summarize, de-duplicate, etc.) multiple API responses 662 to generate the action plan response data 638. In some examples, the action plan response data 638 may be the same or similar to the API response(s) 662. In some examples, the action plan response data 638 may include an identifier associated with the responding component 560 that provided the API response 662. For example, the (additional/second) action plan response data 638 may include first weather information from a first weather skill component, second weather information from a second weather skill component, third weather information from a search engine component, etc. In some embodiments, the action plan execution component 545 may remove/filter information from the API response 662 that is determined to include information not beneficial to the processing by the generative model 545.

The action plan execution component 525 may send (step 11) the (additional/second) action plan response data 638 to the prompt generation component 540. The information from the API response(s) 662 may be included, by the prompt generation component 540, in a (additional/second) prompt to the generative model 545. The prompt generation component 540 may generate the second prompt 642 to include the action plan response data 638 or a representation thereof. The second prompt 642 may also include information from the prior/first prompt (from step 6). For example, the second prompt 642 may include the user input data 505 (or a representation thereof), the relevant information for processing the user input data 505 (e.g., relevant context data, relevant API information, relevant exemplars, etc.), the processing stages information, and the action plan response data 638 (from step 11). In some embodiments, the second prompt 642 may also include at least a portion of the GM response 646 generated during a prior iteration of processing (e.g., the outputs based on performing the task generation stage and the action generation stage) to indicate actions/results of the prior iteration of processing by the generative model 545. The second prompt 642 may include an indicator (e.g., label, identifier, etc.) associated with the action plan response data 638 to indicate, to the generative model 545, that the string of characters/tokens following the indicator represent information determined based on performance of the actions determined during the action generation stage.

The second prompt 642 may be sent (step 12) to the generative model 545 for processing. At this point, the generative model 545 may perform the action generation stage of processing the results of the performed actions, which may involve interpreting or understanding the results included in the action plan response data 638. The generative model 545 may generate (step 13) a (additional/second) GM response 646 based on the second prompt 642. The second prompt 642 may include a request or directive to the generative model 545 to perform further processing with respect to the user input data 505. As described above, the second prompt 642 may provide, among other things, responses/results of performance of the action determined by the generative model 545 determined during the prior iteration of processing. The generative model 545 may generate further actions to be performed to respond to the user input data 505 (as part of the action generation stage) or may generate a (final/user-facing) response to the user input data 505 (as part of the response generation stage).

An example second prompt 642 may be:

```
    {
    Please process the following user input and context data to determine at least one
action or API to execute and generate a response to the user.
    First determine a task to perform (use “Task” label), then determine an API to
perform the task (use “Action” label), then process the results from the API, and then generate a
response to the user input (use “Response” label). You may determine multiple tasks to perform.
You may have to process iteratively.
  User: Turn on living room TV
  Available context:
    User devices: “living room TV” = [device id]
    “living room TV” device state = Off
    Available APIs:
    TurnOn.device (device)
    TurnVolumeUp.device (device)
    SetTVChannel (device, input channel)
  Prior Iteration:
    Action: TurnOn.device (device = “living room TV”)
  TurnOn.device (device = “living room TV”); API response: “living room TV” device
state = ON
}
```

Based on the above example prompt 642, an example GM response 646 may be:

{
Task: User wants to turn on living room TV that is operation of a user device.
Action: I need an API to operate a device. TurnOn.device (device = “living room TV”)
Action result is “living room TV” device state = ON
Response: The living room TV is on now. Can I help you with anything else?
}

As described herein, the generative model 545 may generate the GM response 646 on tokens-by-tokens basis. As such, in some examples, the second GM response 646 may include additional tokens (e.g., newly generated tokens) to the first GM response 646 (from step 7). In other examples, the second GM response 646 may include different tokens than the first GM response 646, where the currently generated tokens may represent outputs for further steps of the action generation stage and/or the response generation stage.

The generative model 545 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 638 (at step 11) (e.g., an API response from a responding component 560 may indicate that additional information is needed to perform an action).

The generative model 545 may determine a (final) response to the user input, where the response is to be presented to the user 505 via the user device 510. In other cases, the response may be presented via another user device 510 associated with the user 505. The generative model 545 may determine the final response based on the results included in the action plan response data 638 (from step 11). For example, the generative model 545 may summarize the results, may combine the results, may generate an interpretation of the results, etc. In a non-limiting example, the generative model 545 may combine weather information from two or more responding components (e.g., combine high/low temperature information from a first responding component with humidity information from a second responding component). In another non-limiting example, the generative model 545 may interpret results from a knowledge base component to determine a response to the specific user query (e.g., from a biographical search result for a historical person, a birthplace and siblings information may be extracted to determine a response to a user query “tell me about [person's] childhood”).

In some examples, the generative model 545 may generate the further action to be performed is requesting additional information from the user 505. Such further action, in some embodiments, may be labeled as “Response” so that the action plan generation component 550 may cause a request to be output to the user 505.

The second GM response 646 may be sent (step 13) to the action plan generation component 550, which may determine (step 14) the (additional/second) action plan data 652. In some examples, the second GM response 646 sent to the action plan generation component 550 may include further action(s)/API(s) to be executed, which may be labeled with “Action.” In some examples, the second GM response 646 may include a final response to the user input, which may be labeled with “Response.”

Based on the tokens corresponding to the “Action” label, the action plan generation component 550 may determine the action plan data 652 to include one or more actions, one or more API calls and/or one or more responding components 560 corresponding to the action(s)/API(s) determined by the generative model 545.

Based on the tokens corresponding to the “Response” label, the action plan generation component 550 may determine the action plan data 652 to include one or more actions, one or more API calls and/or one or more responding components 560 to present the output tokens to the user 505 as a response to the user input. For example, the action plan data 652 may include an identifier for the SSG component 556 to cause the output tokens, generated by the generative model 545, to be presented as synthesized speech. As another example, the action plan data 652 may include an identifier for the responding component 560 capable of generating outputs in more than one form (e.g., a multi-modal output component) to cause the tokens to be presented as synthesized speech, displayed text/graphics, and/or other types of outputs.

The (second) action plan data 652 may be sent (step 14) to the action plan execution component 525, and as described herein, the action plan execution component 525 may determine executable API calls based on the action plan data 652. If the action plan data 652 represents additional actions to be performed, then the action plan execution component 525 may cause the corresponding responding component(s) 560 to perform the additional action(s) and corresponding response(s) (e.g., API responses 662) may be communicated to the prompt generation component 540 (via the action plan execution component 525 and action plan response data 638) to initiate another iteration of processing by the generative model 545 with respect to the user input data 505. If the action plan data 652 represents a response to be presented to the user 505, then the action plan execution component 525 may cause the corresponding responding component(s) 560 to determine output data (e.g., responsive output data 562 shown in FIG. 5) that may be presented via the user device 510. For example, the responsive output data 562 may be sent to the user device 510 via the orchestrator component 730 or another system component(s) 520 (described in relation to FIG. 7).

In some embodiments, when further actions are generated by the generative model 545 to be performed with respect to the user input data 505, the generative model orchestrator component 160 may perform another iteration of processing, which may involve generating another prompt 642 to the generative model 545, generating another GM response 646 that may be used to determine further action plan data 652. The generative model 545 may generate tokens corresponding to the action generation stage and/or the response generation stage during the further iteration.

In some embodiments, when a final response is generated by the generative model 545, further processing with respect to the user input data 505 by the generative model orchestrator component 160 may be ceased (e.g., processing with respect to the user input data 505 by the generative model orchestrator component 160 may be complete). The generative model orchestrator component 160 may process with respect to a subsequently received user input, which may or may not be part of the same dialog session as the prior/already processed user input data 505.

The responsive output data 562 may include one or more of output audio data representing synthesized speech, text data for display, image for display, graphics/icons for display, media (e.g., video, music, background music, notification sounds, etc.) for playback, and other data. In some embodiments, the responsive output data 562 may include placement information representing where (e.g., top banner, left portion, center of screen, overlay on current visual, etc.) on the display screen of the user device 510 the output data is to be displayed. In some embodiments, the responsive output data 562 may be determined/provided by the responding component 560. In some embodiments, another system component 520 may process the responsive output data 562 prior to sending to the user device 510 to ensure that the responsive output data is formatted for the particular user device 510.

Referring again to FIG. 5, as shown, the system component(s) 520 may include a compliance component 570. In some embodiments, the compliance component 570 may be included in the generative model orchestrator component 160. In other embodiments, the compliance component 570 may be one of the responding components 560 and the action plan generation component 550 may cause the action plan execution component 525 to send an API request to the compliance component 570 when processing by the compliance component 570 is to be performed.

The compliance component 570 may be configured to determine whether an output of the generative model 545 is appropriate for output to the user 505. In some embodiments, the compliance component 570 may be configured to process generative model output (e.g., the GM response 646) representing outputs/tokens generated by the generative model 545 during processing of the user input data 505. The model output may include tokens generated during the task generation stage, the action generation stage or the response generation stage. The compliance component 545 may also or instead determine whether an input to the generative model 545 (e.g., a user request, an output of another system component of the system 100) is appropriate and/or that the input will result in the generative model 545 generating an output that is appropriate to present to the user 505. For this determination, the compliance component 570 may process the user input data 505 or a portion or representation thereof. In some embodiments, the compliance component 570 may process other data (e.g., context data, user profile data, system configuration/policy data, etc.) to determine whether the generated response and/or the input is appropriate.

In some embodiments, the compliance component 570 may determine whether the model output/GM response 646 and/or the user input data 505 corresponds to training data used to configure the generative model 545 (e.g., the model output or user input is semantically or lexically similar to the training data, the model output or user input corresponds to functionality (e.g., topics, categories, actions, etc.) that the model is trained for, etc.). Additionally or alternatively, the compliance component 570 may determine whether the model output/GM response 646 and/or the user input data 505 corresponds to one or more words or phrases determined to be confidential, sensitive, or offensive. Additionally or alternatively, the compliance component 570 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 570 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 570 may process the user input data 505 when it is received by the generative model orchestrator component 160 and in some cases may process in parallel to the generative model orchestrator component 160. In some embodiments, the compliance component 570 may process the model output as the generative model 545 generates the output tokens. In other embodiments, the compliance component 570 may process the model output after the generative model 545 has generated tokens for a particular processing stage (e.g., after the task generation stage is completed, after the action generation stage is completed, after the response generation stage is completed, etc.).

If the compliance component 570 determines that the model output or the user input data 505 is appropriate, then the generative model orchestrator component 160 may continue processing with respect to the user input data 505. If the compliance component 570 determines that the model output is not appropriate, then one or more remedial actions may be performed. One example remedial action may involve prompting the generative model 545 to generate a new/modified model output. In such examples, additional prompt data may be determined, which may include the original prompt data, the initial model output, and an indication that the initial model output is not appropriate for output to the user 505. The additional prompt data may include a request or directive to the generative model 545 to generate model output that is appropriate for output to the user 505. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 570 may cause the system to output a response indicating where (e.g., a source external to the system components 520) the included/outputted information may be found. For example, the response may include an indication of a source of the training data or the data (e.g., API response 662) that the response is based on (e.g., the indication may include a description of an owner of the intellectual property rights corresponding to the training data/the response information, a hyperlink to the source, etc.). In some embodiments the compliance component 570 may determine that the model generated response is based on (e.g., summarizing, using, similar to, etc.) data that protected by intellectual property rights (or other laws), and instead of outputting the generative model generated response (e.g., GM response 646). In some embodiments the responsive output data 562 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 570 may determine that the user input data 505 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the generative model orchestrator component 160 of the user input data 505, and the system may output a template response (e.g., “I cannot process this request” or “The requested data is protected by intellectual property rights”, etc.).

As shown in FIG. 5, the system component(s) 520 may include a personalized context component 565. In some embodiments, the personalized context component 565 may be included in the generative model orchestrator component 160. In other embodiments, the personalized context component 565 may be one of the responding components 560 and the action plan generation component 550 may cause the action plan execution component 525 to send an API request to the personalized context component 565.

The personalized context component 565 may be configured to determine personalized context data including context data corresponding to the user input data 505 and/or the user 505. In some embodiments, the initial plan generation component 535 may request personalized context data to include in the prompt 642. In other embodiments, other system component(s) 520, such as the generative model 545, may request personalized context data (e.g., to determine a personalized response to a user input). The personalized context data may include user preferences, past user inputs, past system outputs for past user inputs from the user 505, past skill/app usage, user-defined items, etc. The personalized context component 565 may infer user preferences from user-provided preferences, past user interactions by the user 505, information related to users similar to the user 505, etc. In some embodiments, the personalized context component 565 may employ one or more techniques to determine the personalized context data; such techniques may include using a rules-engine, using one or more machine learning models (including a generative model), topic determination techniques, neural retrieval search techniques, etc.

In examples, the personalized context component 565 may receive the user input data 505, task data representing a current task being performed/processed, and/or model output indicating that an ambiguity exists or additional information is needed to generate a response to the user input. The personalized context component 565 may receive a query in some examples, which may include an identifier for the user 505. In a non-limiting example, the personalized context component 565 may receive the following example requests: “Does the user prefer to use [Music Service 1] or [Music Service 2] for playing music,” or “What kind of music does the user like?” The personalized context component 565 determine example personalized context data including “The user prefers [Music Service 1]” or “The user likes [music genre]”).

Further information related to the SSG component 556 and the skill/app component 554 is described herein in relation to FIG. 7.

In some embodiments, the generative model 545 may be fine-tuned to perform a particular task(s). Fine-tuning of the generative model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system components 520 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the generative model 545 may start processing a first portion of the prompt 642 while the prompt generation component 535 determines a second/subsequent portion of the prompt 642. As another example, the action plan generation component 550 may start processing a first portion of the GM response 646 while the generative model 545 is generating a second/subsequent portion of the GM response 646.

The system 100 may operate using various components as described in FIG. 7. The various components may be located on same or different physical devices. Communication between various components may occur directly or across a network(s) 199. The user device 510 may include audio capture component(s), such as a microphone or array of microphones of a user device 510, captures audio 710 and creates corresponding audio data. Once speech is detected in audio data representing the audio 710, the user device 510 may determine if the speech is directed at the user device 510/system component(s). In at least some embodiments, such determination may be made using a wakeword detection component 720. The wakeword detection component 720 may be configured to detect various wakewords. In at least some examples, each wakeword may correspond to a name of a different digital assistant. An example wakeword/digital assistant name is “Alexa.” In another example, input to the system may be in form of text data 713, for example as a result of a user typing an input into a user interface of user device 510. Other input forms may include indication that the user has pressed a physical or virtual button on user device 510, the user has made a gesture, etc. The user device 510 may also capture images using camera(s) of the user device 510 and may send image data 721 representing those image(s) to the system component(s). The image data 721 may include raw image data or image data processed by the user device 510 before sending to the system component(s). The image data 721 may be used in various manners by different components of the system to perform operations such as determining whether a user is directing an utterance to the system, interpreting a user command, responding to a user command, etc. In some embodiments, the user input data 505 (described in relation to FIG. 5) may include one or more the audio 710, the audio data 711, the text data 713 and the image data 721.

The wakeword detection component 720 of the user device 510 may process the audio data, representing the audio 710, to determine whether speech is represented therein. The user device 510 may use various techniques to determine whether the audio data includes speech. In some examples, the user device 510 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 510 may implement a classifier configured to distinguish speech from background noise. The classifier may be implemented by techniques such as linear classifiers, support vector machines, and decision trees. In still other examples, the user device 510 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 710, is analyzed to determine if specific characteristics of the audio data match preconfigured acoustic waveforms, audio signatures, or other data corresponding to a wakeword.

Thus, the wakeword detection component 720 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 720 may be built on deep neural network (DNN)/recursive neural network (RNN) structures directly, without HMM being involved. Such an architecture may estimate the posteriors of wakewords with context data, either by stacking frames within a context window for DNN, or using an RNN. Follow-on posterior threshold tuning or smoothing is applied for decision making. Other techniques for wakeword detection, such as those known in the art, may also be used.

Once the wakeword is detected by the wakeword detection component 720 and/or input is detected by an input detector, the user device 510 may “wake” and begin transmitting audio data 711, representing the audio 710, to the system component(s) 520. The audio data 711 may include data corresponding to the wakeword; in other embodiments, the portion of the audio corresponding to the wakeword is removed by the user device 510 prior to sending the audio data 711 to the system component(s) 520. In the case of touch input detection or gesture-based input detection, the audio data may not include a wakeword.

In some implementations, the system 100 may include more than one system component(s). The system component(s) 520 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 720 may result in sending audio data to system component(s) 520a for processing while detection of the wakeword “Computer” by the wakeword detector may result in sending audio data to system component(s) 520b for processing. The system may have a separate wakeword and system for different skills/systems (e.g., “Castle Adventure” for a game play skill/system component(s) 520c) and/or such skills/systems may be coordinated by one or more skill component(s) 554 of one or more system component(s) 520.

The user device 510/system component(s) 520 may also include a system directed input detector 785. The system directed input detector 785 may be configured to determine whether an input to the system (for example speech, a gesture, etc.) is directed to the system or not directed to the system (for example directed to another user, etc.). The system directed input detector 785 may work in conjunction with the wakeword detection component 720. If the system directed input detector 785 determines an input is directed to the system, the user device 510 may “wake” and begin sending captured data for further processing. If data is being processed the user device 510 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector 785 determines an input is not directed to the system (such as a speech or gesture directed to another user) the user device 510 may discard the data and take no further action for processing purposes. In this way the system 100 may prevent processing of data not directed to the system, thus protecting user privacy. As an indicator to the user, however, the system may output an audio, visual, or other indicator when the system directed input detector 785 is determining whether an input is potentially device directed. For example, the system may output an orange indicator while considering an input and may output a green indicator if a system directed input is detected. Other such configurations are possible.

Upon receipt by the system component(s) 520, the audio data 711 may be sent to an orchestrator component 730 and/or the generative model orchestrator component 160. The orchestrator component 730 may include memory and logic that enables the orchestrator component 730 to transmit various pieces and forms of data to various components of the system, as well as perform other operations as described herein. In some embodiments, the orchestrator component 730 may optionally be included in the system component(s) 520. In embodiments where the orchestrator component 730 is not included in the system component(s) 520, the audio data 711 may be sent directly to the generative model orchestrator component 160. Further, in such embodiments, each of the components of the system component(s) 520 may be configured to interact with the generative model orchestrator component 160, the action plan execution component XXR45, the API provider component, and/or other component(s).

In some embodiments, the system component(s) 520 may include an arbitrator component 782, which may be configured to determine whether the orchestrator component 730 and/or the generative model orchestrator component 160 are to process with respect to user input data. In some embodiments, the generative model orchestrator component 160 may be selected to process with respect to the audio data 711 only if the user 505 associated with the audio data 711 (or the user device 510 that captured the audio 710) has previously indicated that the generative model orchestrator component 160 may be selected to process with respect to user inputs received from the user 505.

In some embodiments, the arbitrator component 782 may determine the orchestrator component 730 and/or the generative model orchestrator component 160 are to process with respect to the audio data 711 based on metadata associated with the audio data 711. For example, the arbitrator component 782 may be a classifier configured to process a natural language representation of the audio data 711 (e.g., output by the ASR component 750) and classify the corresponding user input as to be processed by the orchestrator component 730 and/or the generative model orchestrator component 160. For further example, the arbitrator component 782 may determine whether the device from which the audio data 711 is received is associated with an indicator representing the audio data 711 is to be processed by the orchestrator component 730 and/or the generative model orchestrator component 160. As an even further example, the arbitrator component 782 may determine whether the user (e.g., determined using data output from the user recognition component 795) from which the audio data 711 is received is associated with a user profile including an indicator representing the audio data 711 is to be processed by the orchestrator component 730 and/or the generative model orchestrator component 160. As another example, the arbitrator component 782 may determine whether the audio data 711 (or the output of the ASR component 750) corresponds to a request representing that the audio data 711 is to be processed by the orchestrator component 730 and/or the generative model orchestrator component 160 (e.g., a request including “let's chat” may represent that the audio data 711 is to be processed by the generative model orchestrator component 160).

In some embodiments, if the arbitrator component 782 is unsure (e.g., a confidence score corresponding to whether the orchestrator component 730 and/or the generative model orchestrator component 160 is to process is below a threshold), then the arbitrator component 782 may send the audio data 711 to both of the orchestrator component 730 and the generative model orchestrator component 160. In such embodiments, the orchestrator component 730 and/or the generative model orchestrator component 160 may include further logic for determining further confidence scores during processing representing whether the orchestrator component 730 and/or the generative model orchestrator component 160 should continue processing, as is discussed further herein below.

The arbitrator component 782 may send the audio data 711 to an ASR component 750. In some embodiments, the component selected to process the audio data 711 (e.g., the orchestrator component 730 and/or the generative model orchestrator component 160) may send the audio data 711 to the ASR component 750. The ASR component 750 may transcribe the audio data 711 into text data. The text data output by the ASR component 750 represents one or more than one (e.g., in the form of an N-best list) ASR hypotheses representing speech represented in the audio data 711. The ASR component 750 interprets the speech in the audio data 711 based on a similarity between the audio data 711 and pre-established generative models. For example, the ASR component 750 may compare the audio data 711 with models for sounds (e.g., acoustic units such as phonemes, senons, phones, etc.) and sequences of sounds to identify words that match the sequence of sounds of the speech represented in the audio data 711. The ASR component 750 sends the text data generated thereby to the arbitrator component 782, the orchestrator component 730, and/or the generative model orchestrator component 160. In instances where the text data is sent to the arbitrator component 782, the arbitrator component 782 may send the text data to the component selected to process the audio data 711 (e.g., the orchestrator component 730 and/or the generative model orchestrator component 160). The text data sent from the ASR component 750 to the arbitrator component 782, the orchestrator component 730, and/or the generative model orchestrator component 160 may include a single top-scoring ASR hypothesis or may include an N-best list including multiple top-scoring ASR hypotheses. An N-best list may additionally include a respective score associated with each ASR hypothesis represented therein.

In some embodiments, the orchestrator component 730 may cause a NLU component (not shown) to perform processing with respect to the ASR data generated by the ASR component 750. The NLU component may attempt to make a semantic interpretation of the phrase(s) or statement(s) represented in the ASR data input therein by determining one or more meanings associated with the phrase(s) or statement(s) represented in the text data. The NLU component may determine an intent representing an action that a user desires be performed and may determine information that allows a device (e.g., the device 510, the system component(s) 520, a skill/app component 554, a skill system component(s) 725, etc.) to execute the intent. For example, if the ASR data corresponds to “play the 5th Symphony by Beethoven,” the NLU component may determine an intent that the system output music and may identify “Beethoven” as an artist/composer and “5th Symphony” as the piece of music to be played. For further example, if the ASR data corresponds to “what is the weather,” the NLU component may determine an intent that the system output weather information associated with a geographic location of the device 510. In another example, if the ASR data corresponds to “turn off the lights,” the NLU component may determine an intent that the system turn off lights associated with the device 510 or the user 505. However, if the NLU component is unable to resolve the entity—for example, because the entity is referred to by anaphora such as “this song” or “my next appointment”—the system can send a decode request to another speech processing system for information regarding the entity mention and/or other context related to the utterance. The natural language processing system may augment, correct, or base results data upon the ASR data as well as any data received from the system.

The NLU component may return NLU results data (which may include tagged text data, indicators of intent, etc.) back to the orchestrator component 730. The orchestrator component 730 may forward the NLU results data to a skill component(s) 554. If the NLU results data includes a single NLU hypothesis, the NLU component and the orchestrator component 730 may direct the NLU results data to the skill component(s) 554 associated with the NLU hypothesis. If the NLU results data includes an N-best list of NLU hypotheses, the NLU component and the orchestrator component 730 may direct the top scoring NLU hypothesis to a skill component(s) 554 associated with the top scoring NLU hypothesis. The system may also include a post-NLU ranker which may incorporate other information to rank potential interpretations determined by the NLU component.

In some embodiments, after determining that the orchestrator component 730 and/or the generative model orchestrator component 160 should process with respect to the user input, the arbitrator 782 may be configured to periodically determine whether the orchestrator component 730 and/or the generative model orchestrator component 160 should continue processing with respect to the user input. For example, after a particular point in the processing of the orchestrator component 730 (e.g., after performing NLU, prior to determining a skill component 554 to process with respect to the user input, prior to performing an action responsive to the user input, etc.) and/or the generative model orchestrator component 160 (e.g., after selecting a task to be completed, after receiving the action response data from the one or more components, after completing a task, prior to performing an action responsive to the user input, etc.) the orchestrator component 730 and/or the generative model orchestrator component 160 may query the arbitrator component 782 has determined that the orchestrator component 730 and/or the generative model orchestrator component 160 should halt processing with respect to the user input. As discussed above, the system 100 may be configured to stream portions of data associated with processing with respect to a user input to the one or more components such that the one or more components may begin performing their configured processing with respect to that data as soon as it is available to the one or more components. As such, the arbitrator component 782 may cause the orchestrator component 730 and/or the generative model orchestrator component 160 to begin processing with respect to a user input as soon as a portion of data associated with the user input is available (e.g., the ASR data, context data, output of the user recognition component 795. Thereafter, once the arbitrator component 782 has enough data to perform the processing described herein above to determine whether the orchestrator component 730 and/or the generative model orchestrator component 160 is to process with respect to the user input, the arbitrator component 782 may inform the corresponding component (e.g., the orchestrator component 730 and/or the generative model orchestrator component 160) to continue/halt processing with respect to the user input at one of the logical checkpoints in the processing of the orchestrator component 730 and/or the generative model orchestrator component 160.

A skill system component(s) 725 may communicate with a skill/app component(s) 554 within the system component(s) 520 directly with the orchestrator component 730 and/or the action plan execution component XXR45, or with other components. A skill system component(s) 725 may be configured to perform one or more actions. An ability to perform such action(s) may sometimes be referred to as a “skill.” That is, a skill may enable a skill system component(s) 725 to execute specific functionality in order to provide data or perform some other action requested by a user. For example, a weather service skill may enable a skill system component(s) 725 to provide weather information to the system component(s) 520, a car service skill may enable a skill system component(s) 725 to book a trip with respect to a taxi or ride sharing service, an order pizza skill may enable a skill system component(s) 725 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 520 may be configured with a skill/app component 554 dedicated to interacting with the skill system component(s) 725. Unless expressly stated otherwise, reference to a skill, skill device, or skill component may include a skill/app component 554 operated by the system component(s) 520 and/or skill/app operated by the skill system component(s) 725. Moreover, the functionality described herein as a skill or skill may be referred to using many different terms, such as an action, bot, app, or the like. The skill component 554 and or skill system component(s) 725 may return output data to the orchestrator component 730.

The system component(s) includes a SSG component 756. The SSG component 756 may generate audio data (e.g., synthesized speech) from text data, text embeddings, text tokens, audio tokens, audio embeddings, etc., using one or more different methods. Data input to the SSG component 756 may come from a skill/app component 554, the orchestrator component 730, the action plan execution component 525, or another component of the system. In one method of synthesis called unit selection, the SSG component 756 matches data against a database of recorded speech. The SSG component 756 selects matching units of recorded speech and concatenates the units together to form audio data. In another method of synthesis called parametric synthesis, the SSG component 756 varies parameters such as frequency, volume, and noise to create audio data including an artificial speech waveform. Parametric synthesis uses a computerized voice generator, sometimes called a vocoder.

The user device 510 may include still image and/or video capture components such as a camera or cameras to capture one or more images. The user device 510 may include circuitry for digitizing the images and/or video for transmission to the system component(s) 520 as image data. The user device 510 may further include circuitry for voice command-based control of the camera, allowing a user 505 to request capture of image or video data. The user device 510 may process the commands locally or send audio data 711 representing the commands to the system component(s) 520 for processing, after which the system component(s) 520 may return output data that can cause the user device 510 to engage its camera.

The system component(s) 520/the user device 510 may include a user recognition component 795 that recognizes one or more users using a variety of data. However, the disclosure is not limited thereto, and the user device 510 may include the user recognition component 795 instead of and/or in addition to the system component(s) 520 without departing from the disclosure.

The user recognition component 795 may take as input the audio data 711 and/or text data output by the ASR component 750. The user recognition component 795 may perform user recognition by comparing audio characteristics in the audio data 711 to stored audio characteristics of users. The user recognition component 795 may also perform user recognition by comparing biometric data (e.g., fingerprint data, iris data, etc.), received by the system in correlation with the present user input, to stored biometric data of users assuming user permission and previous authorization. The user recognition component 795 may further perform user recognition by comparing image data (e.g., including a representation of at least a feature of a user), received by the system in correlation with the present user input, with stored image data including representations of features of different users. The user recognition component 795 may perform additional user recognition processes, including those known in the art.

The user recognition component 795 determines scores indicating whether user input originated from a particular user. For example, a first score may indicate a likelihood that the user input originated from a first user, a second score may indicate a likelihood that the user input originated from a second user, etc. The user recognition component 795 also determines an overall confidence regarding the accuracy of user recognition operations.

Output of the user recognition component 795 may include a single user identifier corresponding to the most likely user that originated the user input. Alternatively, output of the user recognition component 795 may include an N-best list of user identifiers with respective scores indicating likelihoods of respective users originating the user input. The output of the user recognition component 795 may be used to inform processing of the arbitrator component 782, the orchestrator component 730, and/or the generative model orchestrator component 160 as well as processing performed by other components of the system.

The system component(s) 520/user device 510 may include a presence detection component that determines the presence and/or location of one or more users using a variety of data.

The system 100 (either on user device 510, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 770 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more internet protocol (IP) addresses, medium access control (MAC) addresses, and/or device identifiers, such as a serial number, of each additional electronic device associated with the identified user account. When a user logs into to an application installed on a user device 510, the user profile (associated with the presented login information) may be updated to include information about the user device 510, for example with an indication that the device is currently in use. Each user profile may include identifiers of components (e.g., responding component(s) 560 such as skills/apps, generative model-based agents, knowledge bases, components for a particular domain, etc.) that the user has enabled. When a user enables a component, the user is providing the system component(s) with permission to allow the component to execute with respect to the user's inputs. If a user does not enable a component, the system component(s) may not invoke that component to execute with respect to the user's inputs.

The profile storage 770 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 770 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

Although the components of FIG. 7 may be illustrated as part of system component(s) 520, user device 510, or otherwise, the components may be arranged in other device(s) (such as in user device 510 if illustrated in system component(s) 520 or vice-versa, or in other device(s) altogether) without departing from the disclosure.

In at least some embodiments, the system component(s) 520 may receive the audio data 711 from the user device 510, to recognize speech corresponding to a spoken input in the received audio data 711, and to perform functions in response to the recognized speech. In at least some embodiments, these functions involve sending directives (e.g., commands), from the system component(s) to the user device 510 (and/or other user devices 510) to cause the user device 510 to perform an action, such as output an audible response to the spoken input via a loudspeaker(s), and/or control secondary devices in the environment by sending a control command to the secondary devices.

Thus, when the user device 510 is able to communicate with the system component(s) over the network(s) 199, some or all of the functions capable of being performed by the system component(s) may be performed by sending one or more directives over the network(s) 199 to the user device 510, which, in turn, may process the directive(s) and perform one or more corresponding actions. For example, the system component(s), using a remote directive that is included in response data (e.g., a remote response), may direct the user device 510 to output an audible response (e.g., using SSG processing performed by an on-device SSG component) to a user's question via a loudspeaker(s) of (or otherwise associated with) the user device 510, to output content (e.g., music) via the loudspeaker(s) of (or otherwise associated with) the user device 510, to display content on a display of (or otherwise associated with) the user device 510, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 505 as part of a shopping function, establishing a communication session (e.g., a video call) between the user 505 and another user, and so on.

In at least some embodiments, the user device 510, may send the audio data 711 to the wakeword detection component 720. If the wakeword detection component 720 detects a wakeword in the audio data 711, the wakeword detection component 720 may send an indication of such detection to the user device 510. In response to receiving the indication, the audio data 711 may be sent to the system component(s) 520 and/or the ASR component of the user device 510. The wakeword detection component 720 may also send an indication, to the user device 510, representing a wakeword was not detected. In response to receiving such an indication, the audio data 711 may not be sent to the system component(s) 520, and the user device 510 may prevent the ASR component of the user device 510 from further processing the audio data 711. In this situation, the audio data 711 can be discarded.

In some embodiments, the user device 510 may include some or all of the components illustrated in FIG. 7 and/or discussed herein above with respect to the system component(s) 520. In other embodiments, the components illustrated in FIG. 7 and/or discussed herein with respect to the system component(s) 520 may be distributed across the user device 510 and the system component(s) 520.

In at least some embodiments, the components of the user device 510 (e.g., on-device components) may not have the same capabilities as the components of the system component(s) 520. For example, on-device components may be configured to generate a response to only a subset of the natural language user inputs that may be handled by the system component(s) 520. For example, such subset of natural language user inputs may correspond to local-type natural language user inputs, such as those controlling devices or components associated with a user's home. In such circumstances the on-device components may be able to more quickly interpret and respond to a local-type natural language user input, for example, than processing that involves the system component(s). If the user device 510 attempts to process a natural language user input for which the on-device components are not necessarily best suited, the language processing results determined by the user device 510 may indicate a low confidence or other metric indicating that the processing by the user device 510 may not be as accurate as the processing done by the system component(s) 520.

In some embodiments, the system component(s) 520 and the user device 510 may process as described herein to generate responses to the user input corresponding to the audio data 711. The system component(s) 520 may send the response to the user device 510 and the user device 510 may determine whether to output the response generated by the system component(s) 520 or the response generated by the user device 510. In some embodiments, the system component(s) 520 may be configured to perform a portion of the processing described herein, such as a portion of processing not performable by the user device 510 and send the result of such processing to the user device 510. The user device 510 may be configured to determine whether to use the result to complete processing to generate the response to the user device 510.

In at least some embodiments, the user device 510 may include, or be configured to use, one or more skill/app components that may operate similarly to the skill/app component(s) 554. The skill/app component(s) on the user device 510 may correspond to one or more domains that are used in order to determine how to act on a spoken input in a particular way, such as by outputting a directive that corresponds to the determined intent, and which can be processed to implement the desired operation. The skill component(s) installed on the user device 510 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally, or alternatively, the user device 510 may be in communication with one or more skill system component(s) 725. For example, a skill system component(s) 725 may be located in a remote environment (e.g., separate location) such that the user device 510 may only communicate with the skill system component(s) 725 via the network(s) 199. However, the disclosure is not limited thereto. For example, in at least some embodiments, a skill system component(s) 725 may be configured in a local environment (e.g., home server and/or the like) such that the user device 510 may communicate with the skill system component(s) 725 via a private network, such as a local area network (LAN).

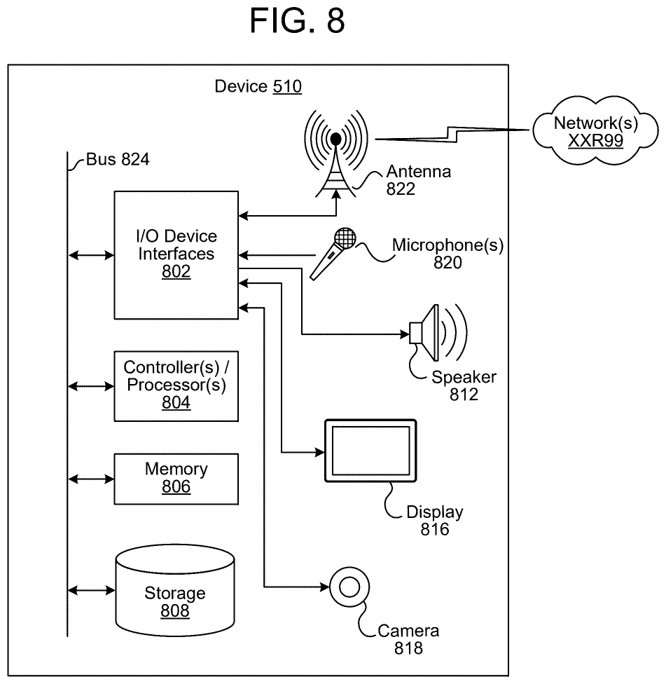

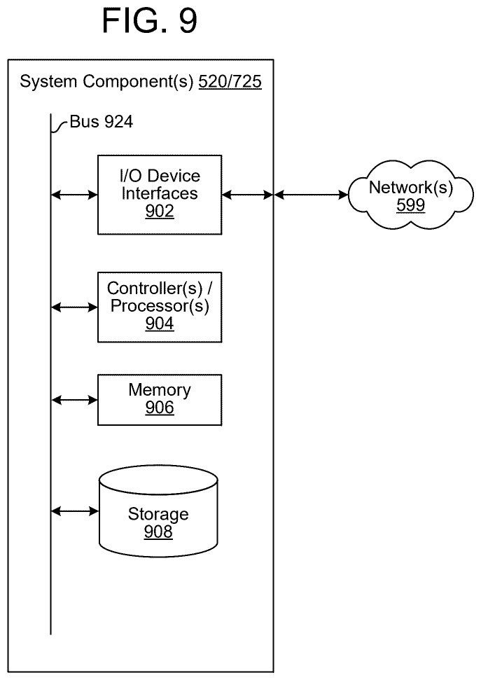

FIG. 8 is a block diagram conceptually illustrating a user device 510 that may be used with the system. FIG. 9 is a block diagram conceptually illustrating example components of a remote device, such as the natural language command processing system component(s), which may assist with ASR processing, NLU processing, etc., and a skill system component(s) 725. System component(s) (520/725) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 510 may operate locally to a user (e.g., within a same environment so the device may receive inputs and playback outputs for the user) the server/system component(s) may be located remotely from the user device 510 as its operations may not require proximity to the user. The server/system component(s) may be located in an entirely different location from the user device 510 (for example, as part of a cloud computing system or the like) or may be located in a same environment as the user device 510 but physically separated therefrom (for example a home server or similar device that resides in a user's home or business but perhaps in a closet, basement, attic, or the like). The system component(s) 520 may also be a version of a user device 510 that includes different (e.g., more) processing capabilities than other user device(s) 510 in a home/office. One benefit to the server/system component(s) being in a user's home/business is that data used to process a command/return a response may be kept within the user's home, thus reducing potential privacy concerns.

Multiple system components (520/725) may be included in the overall system of the present disclosure, such as one or more natural language processing system component(s) 520 for performing ASR processing, one or more natural language processing system component(s) 520 for performing NLU processing, one or more skill system component(s) 725, etc. In operation, each of these systems may include computer-readable and computer-executable instructions that reside on the respective device (520/725), as will be discussed further below.

Each of these devices (510/520/725) may include one or more controllers/processors (804/904), which may each include a central processing unit (CPU) for processing data and computer-readable instructions, and a memory (806/906) for storing data and instructions of the respective device. The memories (806/906) may individually include volatile random-access memory (RAM), non-volatile read only memory (ROM), non-volatile magnetoresistive memory (MRAM), and/or other types of memory. Each device (510/520/725) may also include a data storage component (808/908) for storing data and controller/processor-executable instructions. Each data storage component (808/908) may individually include one or more non-volatile storage types such as magnetic storage, optical storage, solid-state storage, etc. Each device (510/520/725) may also be connected to removable or external non-volatile memory and/or storage (such as a removable memory card, memory key drive, networked storage, etc.) through respective input/output device interfaces (802/902).

Computer instructions for operating each device (510/520/725) and its various components may be executed by the respective device's controller(s)/processor(s) (804/904), using the memory (806/906) as temporary “working” storage at runtime. A device's computer instructions may be stored in a non-transitory manner in non-volatile memory (806/906), storage (808/908), or an external device(s). Alternatively, some or all of the executable instructions may be embedded in hardware or firmware on the respective device in addition to or instead of software.

Each device (510/520/725) includes input/output device interfaces (802/902). A variety of components may be connected through the input/output device interfaces (802/902), as will be discussed further below. Additionally, each device (510/520/725) may include an address/data bus (824/924) for conveying data among components of the respective device. Each component within a device (510/520/725) may also be directly connected to other components in addition to (or instead of) being connected to other components across the bus (824/924).

Referring to FIG. 8, the user device 510 may include input/output device interfaces 802 that connect to a variety of components such as an audio output component such as a speaker 812, a wired headset or a wireless headset (not illustrated), or other component capable of outputting audio. The user device 510 may also include an audio capture component. The audio capture component may be, for example, a microphone 820 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 510 may additionally include a display 816 for displaying content. The user device 510 may further include a camera 818.

Via antenna(s) 822, the input/output device interfaces 802 may connect to one or more networks 599 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 599, the system may be distributed across a networked environment. The I/O device interface (802/902) may also include communication components that allow data to be exchanged between devices such as different physical servers in a collection of servers or other components.

The components of the user device(s) 510, the natural language command processing system component(s), or a skill system component(s) 725 may include their own dedicated processors, memory, and/or storage. Alternatively, one or more of the components of the user device(s) 510, the natural language command processing system component(s), or a skill system component(s) 725 may utilize the I/O interfaces (802/902), processor(s) (804/904), memory (806/906), and/or storage (808/908) of the user device(s) 510, natural language command processing system component(s), or the skill system component(s) 725, respectively. Thus, the ASR component 750 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the user device 510, the natural language command processing system component(s), and a skill system component(s) 725, as described herein, are illustrative, and may be located as a stand-alone device or may be included, in whole or in part, as a component of a larger device or system. As can be appreciated, a number of components may exist either on a system component(s) and/or on user device 510. Unless expressly noted otherwise, the system version of such components may operate similarly to the device version of such components and thus the description of one version (e.g., the system version or the local version) applies to the description of the other version (e.g., the local version or system version) and vice-versa.

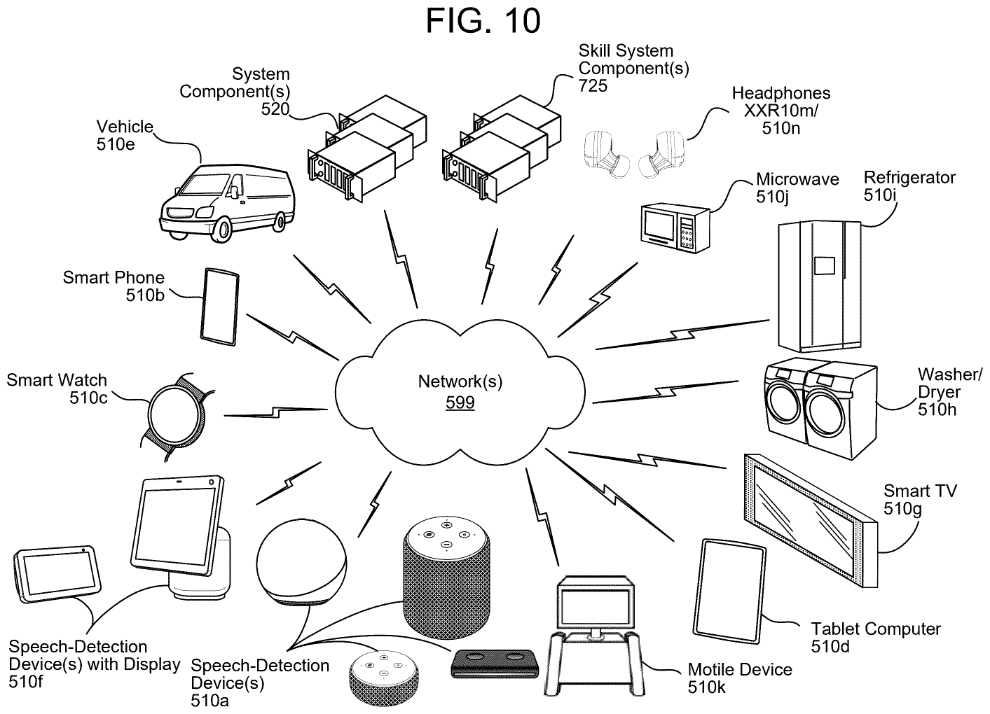

As illustrated in FIG. 10, multiple devices (510a-510n, 520, 725) may contain components of the system and the devices may be connected over a network(s) 599. The network(s) 599 may include a local or private network or may include a wide network such as the Internet. Devices may be connected to the network(s) 599 through either wired or wireless connections. For example, a speech-detection user device 510a, a smart phone 510b, a smart watch 510c, a tablet computer 510d, a vehicle 510e, a speech-detection device with display 510f, a display/smart television 510g, a washer/dryer 510h, a refrigerator 510i, a microwave 510j, autonomously motile user device 510k (e.g., a robot), etc., may be connected to the network(s) 599 through a wireless service provider, over a Wi-Fi or cellular network connection, or the like. Other devices are included as network-connected support devices, such as the natural language command processing system component(s) 520, the skill system component(s) 725, and/or others. The support devices may connect to the network(s) 599 through a wired connection or wireless connection. Networked devices may capture audio using one-or-more built-in or connected microphones or other audio capture devices, with processing performed by ASR components, NLU components, or other components of the same device or another device connected via the network(s) 599, such as the ASR component 750, etc. of the natural language command processing system component(s) 520.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

1. A computer-implemented method comprising:
receiving first data to determine a predicted action of a user, wherein the first data indicates at least one or more inferred interests of the user;
generating first prompt data including the first data and a request to determine the predicted action based on the first data;
using a language model to process the first prompt data and determine a description of the predicted action;
performing a semantic query of a system-performable action storage to determine a system-performable action whose description is semantically similar to the description of the predicted action as determined by the language model;
determining one or more tasks to be performed to execute the system-performable action;
generating second prompt data including two or more trigger events and a request to determine one or more trigger events, of the two or more trigger events, for triggering performance of the one or more tasks;
storing first proactive task plan data including a user identifier of the user, second data representing the one or more tasks, and third data representing the one or more trigger events;
after storing the first proactive task plan data, receiving event data indicating the one or more trigger events has occurred;
based on the event data corresponding to the one or more trigger events, identifying the first proactive task plan data in a storage component;
after identifying the first proactive task plan data in the storage component, causing the one or more tasks to be performed to generate first proactive output data; and
outputting the first proactive output data using one or more devices associated with the user identifier.

2. The computer-implemented method of claim 1, further comprising:
determining, by the language model during a dialog with the user, that a dialog with the user has ended and proactive content is to be presented to the user;
based on the language model determining proactive content is to be presented to the user, identifying a plurality of stored proactive task plan data associated with the user identifier of the user;
determining proactive content data corresponding to at least one instance of proactive content capable of being presented to the user;
processing the plurality of stored proactive task plan data and the proactive content data to determine, from among the plurality of stored proactive task plan data, that one or more tasks, in second proactive task plan data of the plurality of stored proactive task plan data, are to be performed;
causing the one or more tasks of the second proactive task plan data to be performed to generate second proactive output data; and
indicating the second proactive output data using one or more devices associated with the user identifier.

3. A computer-implemented method comprising:
receiving first data indicating one or more interests of a user;
generating first prompt data requesting a generative model determine a predicted action of the user based on the first data;
using the generative model to process the first prompt data and determine the predicted action;
determining one or more tasks to be performed to execute the predicted action;
determining one or more trigger events for triggering performance of the one or more tasks;
after determining the one or more trigger events, determining the one or more trigger events has occurred;
based on the one or more trigger events occurring, causing the one or more tasks to be performed to generate first proactive output data; and
outputting the first proactive output data using one or more devices of the user.

4. The computer-implemented method of claim 3, further comprising:
determining, by the generative model during a dialog with the user, that proactive content is to be presented to the user;
based on the generative model determining proactive content is to be presented to the user, identifying a plurality of stored proactive task plan data associated with a user identifier of the user, the plurality of stored proactive task plan data comprising first proactive task plan data including the one or more tasks and the one or more trigger events;
determining proactive content data corresponding to at least one instance of proactive content capable of being presented to the user;
processing the plurality of stored proactive task plan data and the proactive content data to determine, from among the plurality of stored proactive task plan data, that the one or more tasks, in the first proactive task plan data, are to be performed;
causing the one or more tasks to be performed to generate second proactive output data; and
outputting the second proactive output data using one or more devices associated with the user identifier.

5. The computer-implemented method of claim 3, further comprising:
performing a search of a storage component, including data related to trigger events, to identify two or more trigger events relating to the predicted action as determined by the generative model; and
using the generative model to determine the one or more trigger events from among the two or more trigger events.

6. The computer-implemented method of claim 3, further comprising:
receiving at least one of:
second data indicating one or more system functionality subscriptions of the user,
third data indicating one or more instances of feedback provided by the user in response to one or more system outputs, and
fourth data indicating one or more actions configured by the user to be performed in response to one or more corresponding trigger events; and
generating the first prompt data to request the generative model determine the predicted action further based on at least one of the second data, the third data, and the fourth data.

7. The computer-implemented method of claim 3, further comprising:
receiving second data indicating the user has updated a stored preference in user profile data; and
using the generative model to process the first prompt data and determine the predicted action in response to receiving the second data.

8. The computer-implemented method of claim 3, further comprising:
receiving second data indicating one or more of:
a first user input subscribing to receiving updates regarding an entity or topic over time, and
a second user input indicating information about an entity or topic is to be prevented from being presented to the user; and
using the generative model to process the first prompt data and determine the predicted action in response to receiving the second data.

9. The computer-implemented method of claim 3, further comprising:
determining a system-performable action corresponding to the predicted action as determined by the generative model; and
determining application programming interface (API) data for executing the system-performable action.

10. The computer-implemented method of claim 9, further comprising:
processing the first prompt data to determine natural language data corresponding to the predicted action; and
determining the system-performable action has a description that is semantically similar to the natural language data.

11. The computer-implemented method of claim 3, further comprising:
after determining the predicted action using the generative model, sending, to an events component, event data indicating the predicted action has been determined; and
determining the one or more tasks based on the event data being sent to the events component.

12. A computing system comprising:
at least one processor; and
at least one memory comprising instructions that, when executed by the at least one processor, cause the computing system to:
receive first data indicating one or more interests of a user;
generate first prompt data requesting a generative model determine a predicted action of the user based on one or more of the first data;
use the generative model to process the first prompt data and determine the predicted action;
determine one or more tasks to be performed to execute the predicted action;
determine one or more trigger events for triggering performance of the one or more tasks;
after determine the one or more trigger events, determining the one or more trigger events has occurred;
based on the one or more trigger events occurring, cause the one or more tasks to be performed to generate first proactive output data; and
output the first proactive output data using one or more devices of the user.

13. The computing system of claim 12, wherein the at least one memory further comprises instructions that, when executed by the at least one processor, further cause the computing system to:
determine, by the generative model during a dialog with the user, that proactive content is to be presented to the user;
based on the generative model determining proactive content is to be presented to the user, identify a plurality of stored proactive task plan data associated with a user identifier of the user, the plurality of stored proactive task plan data comprising first proactive task plan data including the one or more tasks and the one or more trigger events;
determine proactive content data corresponding to at least one instance of proactive content capable of being presented to the user;
process the plurality of stored proactive task plan data and the proactive content data to determine, from among the plurality of stored proactive task plan data, that the one or more tasks, in the first proactive task plan data, are to be performed;
cause the one or more tasks to be performed to generate second proactive output data; and
output the second proactive output data using one or more devices associated with the user identifier.

14. The computing system of claim 12, wherein the at least one memory further comprises instructions that, when executed by the at least one processor, further cause the computing system to:
perform a search of a storage component, including data related to trigger events, to identify two or more trigger events relating to the predicted action as determined by the generative model; and
use the generative model to determine the one or more trigger events from among the two or more trigger events.

15. The computing system of claim 12, wherein the at least one memory further comprises instructions that, when executed by the at least one processor, further cause the computing system to:
receive at least one of:
second data indicating one or more system functionality subscriptions of the user,
third data indicating one or more instances of feedback provided by the user in response to one or more system outputs, and
fourth data indicating one or more actions configured by the user to be performed in response to one or more corresponding trigger events; and
generate the first prompt data to request the generative model determine the predicted action further based on at least one of the second data, the third data, and the fourth data.

16. The computing system of claim 12, wherein the at least one memory further comprises instructions that, when executed by the at least one processor, further cause the computing system to:
receive second data indicating the user has updated a stored preference in user profile data; and
use the generative model to process the first prompt data and determine the predicted action in response to receiving the second data.

17. The computing system of claim 12, wherein the at least one memory further comprises instructions that, when executed by the at least one processor, further cause the computing system to:
receive second data indicating one or more of:
a first user input subscribing to receiving updates regarding an entity or topic over time, and
a second user input indicating information about an entity or topic is to be prevented from being presented to the user; and
use the generative model to process the first prompt data and determine the predicted action in response to receiving the second data.

18. The computing system of claim 12, wherein the at least one memory further comprises instructions that, when executed by the at least one processor, further cause the computing system to:
determine a system-performable action corresponding to the predicted action as determined by the generative model; and
determine application programming interface (API) data for executing the system-performable action.

19. The computing system of claim 18, wherein the at least one memory further comprises instructions that, when executed by the at least one processor, further cause the computing system to:
process the first prompt data to determine natural language data corresponding to the predicted action; and
determine the system-performable action has a description that is semantically similar to the natural language data.

20. The computing system of claim 12, wherein the at least one memory further comprises instructions that, when executed by the at least one processor, further cause the computing system to:
after determining the predicted action using the generative model, sending, to an events component, event data indicating the predicted action has been determined; and
determining the one or more tasks based on the event data being sent to the events component.
